(19) United States
(12) Patent Application Publication
(10) Pub. No.: US 2017/0277663 A1
(43) Pub. Date: Sep. 28, 2017

(54) DIGITAL CONTENT CONVERSION AND PUBLISHING SYSTEM

(71) Applicant: Magnificent Marketing LLC, Austin, TX (US)

(72) Inventors: David Reimherr, Austin, TX (US); Stephen James Viner, Austin, TX (US); Robert Harwood Shepherd, San Jose, CA (US)

(21) Appl. No.: 15/080,133

(22) Filed: Mar. 24, 2016

(51) Int. Cl. G06F 17/21; G06F 3/0481; G06F 17/22

(52) U.S. Cl. CPC G06F 17/218; G06F 17/2247; G06F 3/0481

(57) ABSTRACT

A digital content conversion system provides a GUI that receives a PDF file. The PDF file is analyzed, and page(s) of the PDF file are identified via the GUI. Text element(s), text element location information, image element(s), and image element location information are extracted from selected pages identified via the GUI. The text element(s) and image element(s) are formatted to provide HTML formatted text data and HTML formatted image data. A composite content element layout is then provided via the GUI that displays the HTML formatted text data and the HTML formatted image data, and selections of a subset of the HTML formatted text data and the HTML formatted image data are received. A command to publish is then received via the GUI and, in response, the subset of HTML formatted text data and the HTML formatted image data is transmitted to a content management system for publishing.

### BACKGROUND

Field of the Disclosure

The present disclosure generally relates to digital content, and more particularly to system for converting and publishing digital content.

Related Art

The growth and use of the Internet opened up a new medium for marketing and advertising. As more and more people spent more and more time online at various websites, advertisers developed a variety of different methods for presenting advertisements and otherwise marketing via those websites on the web pages frequented by the website users. Currently, one of the top methods for advertising or marketing to website users is via advertising space that is purchased from website providers, and advertisements that are placed in the advertising space on the web pages being viewed by the website users. However, website users have become less and less willing to even allow those advertisements to be displayed on their browsers by the websites they frequent, and software like AdBlock (e.g., available from BetaFish, Inc. of Watkinsville, Ga., United States) and AdBlock Plus (an open source product available at https://adblockplus.org) has been created and adopted by website users to provide content filtering and other ad blocking functionality to Internet browsers to prevent web page advertising elements from displaying advertisements. Furthermore, new Internet browsers and Internet browser updates are expected to begin providing for the blocking of such advertisements by default.

As such, advertisers have begun looking to different methods to advertise and otherwise market through the Internet. “Content marketing” is one of those advertising/marketing methods, and generally provides for strategic marking based on creating and distributing valuable, relevant, and consistent content to a clearly-defined audience in order to attract and/or retain customers, and ultimately drive profitable customer actions. Specifically, content marketing may include the creation and sharing of media and published content (e.g., articles about a particular subject) by companies that sell products and/or services that are related to the subject matter of that content. The focus of that content is typically the needs of the customer, and the relevant content may be regularly delivered in a variety of formats (e.g., news, videos, white papers, e-books, infographics, email newsletters, case studies, podcasts, how-to guides, question and answer articles, photos, web logs (“blogs”), etc.) In a specific example, a company may employ a “blogger” (i.e., a person that creates content posts in a blog) to create web content for provisioning to their existing or prospective customers as part of a content marketing strategy.

However, the costs associated with having employee(s) create web content for content marketing strategies can be substantial, and thus those costs are typically only incurred by relatively large companies. One solution to this problem is for companies or advertisers to buy web content that has been created independently from that company (e.g., by independent bloggers) and that is relevant to the products and/or services provided by that company, and present that web content to existing or prospective customers (the provision of web content in such a manner is sometimes referred to as “sponsored content”). While such solutions relieve the need to employ content creators, it has been found that the universe of web content that is relevant to the products and/or services of any particular company is limited. For example, one of the largest sources of web content that is available for content marketing is provided through content management systems that provide for the management of content via the blogs discussed above (e.g., WordPress, an open source product developed by the WordPress Foundation and available at www.wordpress.com).

However, the inventors of the present disclosure have recognized a much larger possible source of content for content marketing that dwarfs the content available by the content management systems discussed above. Physical and digital publishers (e.g., publishers of physical and digital newspapers, magazines, books, etc.) create content at a steady rate as part of their publishing business, and many existing physical and digital publishers include huge stores of previously created content as a result of previous business operations. Such previously and newly created content is predominantly stored by the physical and digital publishers in Portable Document Format (“PDF”) files, which is a file format that is used to present documents in a manner that is independent of application software, hardware, and operating system, and encapsulates a complete description of a fixed-layout flat document (including text, fonts, images/graphics, etc.) that is needed to display and/or print the content. For example, physical and/or digital magazine publisher may create a magazine issue in a PDF file, and that PDF file may be provided to physically print or digitally publish the magazine issue, as well as store the magazine issue.

However, content such as the content created and stored in PDF files discussed above is not easily or readily available for use in content marketing, as the content provided in the PDF files cannot be easily transferred to the content management systems discussed above that are the predominant source of content for content marketing, while many elements of the content in the PDF files are not valuable or worthwhile for use as content in content marketing. As a result, physical and digital publishers that wish to provide web content for content marketing typically must employ separate web content creators to create separate web content for use in content marketing. However, it has been found that such physical and digital publishers typically focus on the “print” or “feature” content/articles they create as part of their physical or digital publishing business, while providing substandard and relatively low value web content. As such, large amounts of content created for physical and/or digital publishing simply is not used in content marketing.

Thus, there is a need for systems and methods that will allow physical and digital publishers to easily leverage the content they create (and have previously created) for physical and digital publishing for use in content marketing.

### BRIEF DESCRIPTION OF THE FIGURES

FIG. 1 is a schematic view illustrating an embodiment of a digital content conversion and publishing system.

FIG. 2 is a schematic view illustrating an embodiment of a content conversion server subsystem used in the digital content conversion and publishing system of FIG. 1.

FIG. 3 is a flow chart illustrating a method for converting digital content for publishing.

FIG. 4 is a screenshot view illustrating a user device displaying a dashboard portion of a Graphical User Interface (GUI).

FIG. 5 is a screenshot view illustrating a user device displaying a content management system connection portion of a GUI.

FIG. 6A is a screenshot view illustrating a user device displaying a digital document provision portion of a GUI.

FIG. 6B is a screenshot view illustrating a user device displaying the use of a digital document provision portion of a GUI.

FIG. 6C is a screenshot view illustrating a user device displaying a dashboard portion of a GUI following the provisioning of a digital document using the digital document provisioning portion of the GUI.

FIG. 7A is a screenshot view illustrating a user device displaying a page selection portion of a GUI.

FIG. 7B is a screenshot view illustrating a user device displaying a user selecting a page using the page selection portion of a GUI.

FIG. 8 is a screenshot view illustrating a user device displaying a page display portion of a GUI.

FIG. 9A is a schematic view illustrating the operation of a portion of the content conversion server subsystem of FIG. 2.

FIG. 9B is a textual view illustrating an embodiment of an extraction file.

FIG. 10A is a screenshot view illustrating a user device displaying a composite content element layout display portion of a GUI.

FIG. 10B is a screenshot view illustrating a user device displaying a user selecting text using the composite content element layout display portion of a GUI.

FIG. 10C is a screenshot view illustrating a user device displaying a user selecting text using the composite content element layout display portion of a GUI.

FIG. 10D is a screenshot view illustrating a user device displaying a user selecting an image using the composite content element layout display portion of a GUI.

FIG. 11 is a screenshot view illustrating a user device displaying a preview portion of a GUI.

FIG. 12 is a screenshot view illustrating a user device displaying a user selecting an image using a content summary portion of a GUI.

FIG. 13 is a screenshot view illustrating a user device displaying a user providing a content summary using an excerpt and categorization portion of a GUI.

FIG. 14 is a screenshot view illustrating a user device displaying a preview portion of a GUI.

FIG. 15 is a screenshot view illustrating a user device displaying a publishing portion of a GUI.

FIG. 16 is a screenshot view illustrating a user device displaying a content management system content summary page.

FIG. 17 is a screenshot view illustrating a user device displaying a content page.

FIG. 18 is a schematic view illustrating an embodiment of a content marketplace.

FIG. 19 is a screenshot view illustrating a user device displaying a sponsored content page.

FIG. 20 is a schematic view illustrating an embodiment of a computing system.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure provides systems and methods for converting digital content for publishing. For example, in the specific embodiments discussed below, the systems and methods of the present disclosure provide for the conversion of content in Portable Document Format (PDF) files into Hypertext Markup Language (HTML) formatted content, and the selective publishing of subsets of that HTML formatted content using a content management system. The systems and methods of the present disclosure address the Internet-centric challenge of publishing a subset of content that is included in a PDF file using a content management system that requires published content to be HTML formatted and provided in a predefined manner. As discussed below, such challenges are addressed by the systems and methods of the present disclosure by providing a Graphical User Interface (GUI) that receives a PDF file from a user, analyzing the PDF file and identifying page(s) of the PDF file via the GUI, and extracting text element(s), text element location information, image element(s), and image element location information from selected pages identified via the GUI by the user. The text element(s) and image element(s) are then formatted (e.g., using respective text element location information and image element location information) to provide HTML formatted text data and HTML formatted image data, and a composite content element layout is provided via the GUI that displays the HTML formatted text data and the HTML formatted image data. A user may then select a subset of the HTML formatted text data and the HTML formatted image data via the GUI, edit any of the subset of the HTML formatted text data and the HTML formatted image data via the GUI, and provide a command to publish once all desired content has been selected, edited, and/or organized. The subset of HTML formatted text data and the HTML formatted image data is then transmitted to a content management system in the predefined manner prescribed by the content management system, and subsequently published by the content management system.

As discussed below, the systems and methods of the present disclosure may be used to develop a machine learning database that can then be leveraged to enhance the operations of those systems and methods. For example, via use of the systems and methods by multiple users over time, user selections of HTML formatted text data and HTML formatted image data may be recorded, stored, and/or otherwise compiled, and that user data may then be analyzed to determine content element types in digital content that are most desirable for publishing via content management systems. Such analysis allows for the systems and methods to identify, for example, the value of HTML formatted text data and HTML formatted image data that is provided in a composite content element layout as discussed above, and suggest the subset of HTML formatted text data and HTML formatted image data that should be provided to the content management system for publishing. Thus, the machine learning database may allow relatively “low value” text elements and image elements identified and/or extracted from a PDF file (e.g., page numbers, image frames, advertisements, etc.) to be automatically disregarded by the systems and methods of the present disclosure, and a relatively “high value” subset of HTML formatted text data and HTML formatted image data to be suggested for publishing with little or no editing required by the user. As such, continual use of the systems and methods of the present disclosure are expected to refine the machine learning subsystem so that users will able to simply provide a PDF file to the system, have that PDF file analyzed by the system, and be presented by the system with a suggested subset of HTML formatted text data and HTML formatted image data so that the user need only provide a command to publish the suggested subset of HTML formatted text data and HTML formatted image data using the content management system (or even have that suggested subset of HTML formatted text data and HTML formatted image data automatically published using the content management system.)

The systems and methods of the present disclosure may be particularly useful by the physical and digital publishers discussed above, and may be used to enable a content marketplace that can connect content creators/sellers with content sponsors/buyers. For example, as discussed above, physical and digital publishers create content in PDF files at a steady rate as part of their publishing business, and may include large stores of previously created content as a result of previous physical and digital publishing operations. One of skill in the art in possession of the present disclosure will recognize how the systems and methods described herein allow such physical and digital publishers to quickly and easily convert subsets of content provided in PDF files for publishing via a content management system. Thus, a vast marketplace of HTML formatted content may be generated using previously and currently created content provided in PDF files, and the content marketplace may be used to connect content creators/sellers that have converted their content via the systems and methods described herein with content sponsors/buyers that wish to leverage that content in, for example, the content marketing strategies discussed above. As such, the systems and methods of the present disclosure may be supplemented with a content marketplace that provides for sponsorship of HTML formatted content by content sponsors/buyers that are matched with the HTML formatted content based on profiles generated for the HTML formatted content, the content sponsors/buyers, content marking strategies, and/or the content creators/sellers.

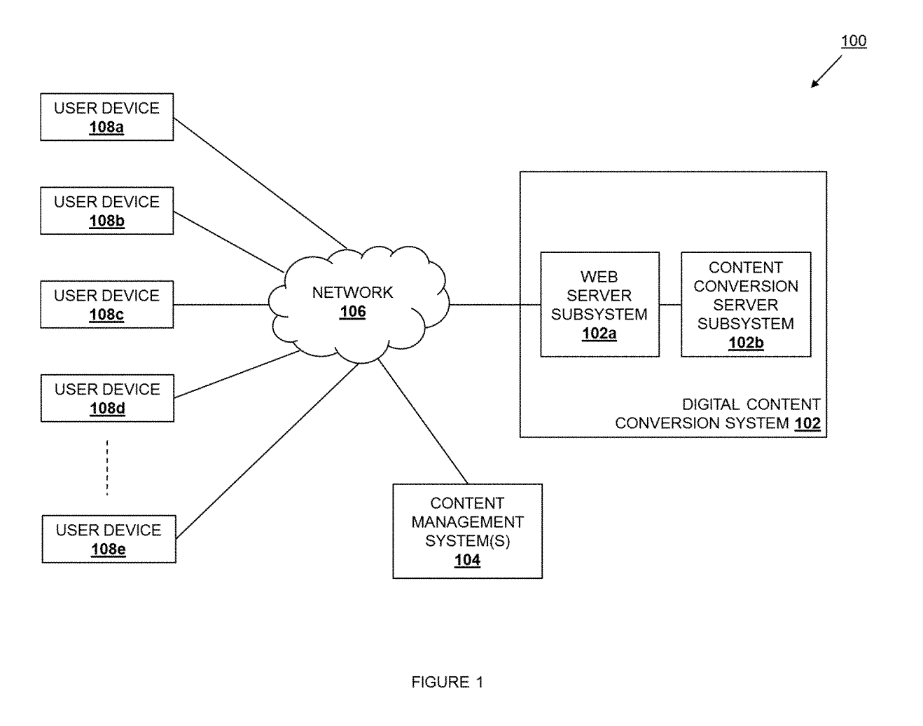

Referring now to FIG. 1, an embodiment of a digital content conversion and publishing system 100 is illustrated. In the illustrated embodiment, the digital content conversion and publishing system 100 includes a digital content conversion system 102 that includes a web server subsystem 102a and a content conversion server subsystem 102b. For example, as discussed below, the web server subsystem 102a may include one or more servers having a processing system (e.g., one or more hardware processors) and a memory system including instructions that, when executed by the processing system, cause the processing system to perform the operations of the web server subsystem 102a discussed below. Furthermore, the content conversion server subsystem 102b may include one or more servers having a processing system (e.g., one or more hardware processors) and a memory system including instructions that, when executed by the processing system, cause the processing system to perform the operations of the content conversion server subsystem 102b discussed below. In the specific examples provided below, the web server subsystem 102a may be optimized to perform the web server operations discussed below, while the content conversion server subsystem 102b may be optimized to perform the content conversion operations discussed below. However, the functionality of the web server subsystem 102a and the content conversion server subsystem 102b may be provided in other devices (e.g., computing devices other than servers), combined into fewer devices (e.g., a single server), and/or distributed across more devices (e.g., computing devices in one or more datacenters) while remaining within the scope of the present disclosure.

The digital content conversion and publishing system 100 also includes one or more content management systems 104 that are coupled to the digital content conversion system 102 through a network 106. In the embodiments illustrated and described below, the content management system(s) 104 allow for the publishing of HTML formatted content on a website such as, for example, a web log (“blog”), a news website, a shopping website, a social network, and/or a variety of other websites known in the art. For example, the content management system(s) 104 may be provided using WordPress (an open-source content management system developed by the WordPress Foundation and available at available at www.wordpress.com). However, other content management systems are envisioned as falling within the scope of the present disclosure, including content management systems such BLOGGER® (an blog publishing content management system provided by GOOGLE® and available at available at www.blogger.com), TUMBLR® (a microblogging platform and social networking content management system provided by YAHOO® and available at www.tumblr.com), Instant Articles (an interactive article publishing service provided by FACEBOOK®), Medium.com (a content management system application available at www.medium.com), DRUPAL® (an open-source content management system application available at www.drupal.com), JOOMLA® (an open-source content management system application available at www.joomla.org), SQUARESPACE® (a content management system application available at www.squarespace.com), and/or other content management systems known in the art that provide a network-accessible programmatic interface that the digital content conversion system 102 may issue commands to in order to effect the publishing of content discussed below.

The digital content conversion and publishing system 100 also includes a plurality of user devices 108a, 108b, 108c, 108d, and up to 108e, each of which is coupled through the network 106 to the digital content conversion system 102 and the content management system 104. In an embodiment, each of the user devices 108a-e may be provided by desktop computing devices, laptop/notebook computing devices, tablet computing devices, mobile phones, servers, and/or other computing devices known in the art. As such, each of the user devices may include a processing system (e.g., one or more hardware processors) and a memory system including instructions that, when executed by the processing system, cause the processing system to perform the operations of the user devices discussed below. As discussed below, users of the user devices 108a-e may have accounts with the content management system(s) 104 that allow the user devices 108a-e to publish content via the content management system(s) 104. For example, the accounts with the content management system(s) 104 may allow users of the user devices 108a-e to publish content for a blog, news website, shopping website, social network, etc., via one or more input fields (e.g., a content title input field, a content body input field, an content image input field, a content summary input field, etc.). As such, the user devices 108a-e may include applications that allow for the provisioning of content to the content management system(s) 104, or that provide network access (e.g., via an Internet browser) to web applications that allow for the provision of content through the network 106 to the content management system(s) 104.

While a specific embodiment of the digital content conversion and publishing system 100 has been illustrated and described, one of skill in the art in possession of the present disclosure will recognize that modification to the embodiment illustrated in FIG. 1 will fall within the scope of the present disclosure. For example, the digital content conversion system 102 may be combined with the content management system 104 such as, for example, when the digital content conversion system is provided by a content management system (e.g., to enable the quick and easily digital content conversion and publishing discussed below.) In another embodiment, while the user devices 108a-e are illustrated and described as separate user devices having users with separate user accounts with the content management system(s) 104, the user devices 108a-e may be grouped (e.g., as part of a single company) and associated with users that share an account with a content management system 104 or have accounts that allow for the provisioning of content to the same content management system 104. As such, a wide variety of modification to the digital content conversion and publishing system 100 is envisioned as falling within the scope of the present disclosure.

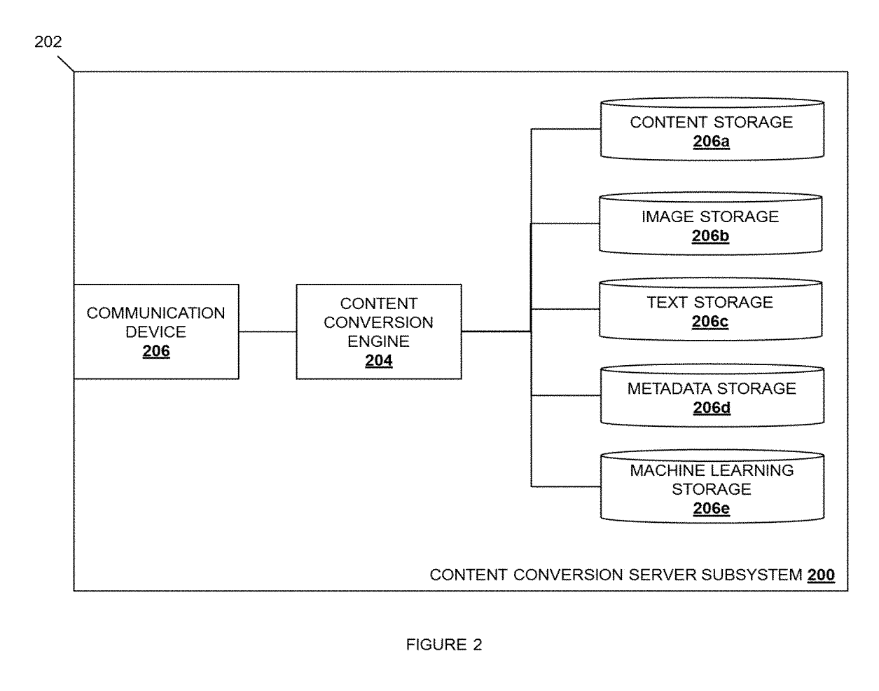

Referring now to FIG. 2, an embodiment of a content conversion server subsystem 200 is illustrated that may be the content conversion server subsystem 102b discussed above with reference to FIG. 1. The content conversion server subsystem 200 may include a chassis 202 that houses the components of the content conversion server subsystem 200, only some of which are illustrated in FIG. 2. While the content conversion server subsystem 200 is illustrated and described as a single server provided in a single chassis, one of skill in the art in possession of the present disclosure will recognize that the content conversion server subsystem 200 may be provided in multiple servers and thus the components illustrated in FIG. 2 may be distributed across multiple chassis (e.g., in a virtual “cloud” environment) while remaining within the scope of the present disclosure. The chassis 202 may house a processing system (not illustrated, but which may be provided by one or more hardware processors) and a memory system (not illustrated, but which may be provided by one or more memory devices) that includes instructions that, when executed by the processing system, cause the processing system to provide a content conversion engine 204 that is configured to perform the functions of the content conversion engines and content conversion server subsystems discussed below.

The chassis 202 may also house a communication device 206 that is coupled to the content conversion engine 204 (e.g., via a coupling between the communication device 206 and the processing system) and that may be provided by a network interface controller (NIC), a wireless communication device, and/or other communication subsystems known in the art that are configured to communicatively couple to another computing device (e.g., the web server subsystem 102a illustrated in FIG. 1, the network 104 illustrated in FIG. 1, etc.). The chassis 202 may also house a storage system (not illustrated, but which may be provided by one or more storage devices) that is coupled to the content conversion engine 204 (e.g., via a coupling between the storage system and the processing system) and that includes one or more databases used by the content conversion engine 204 as discussed below. For example, in the illustrated embodiment, the storage device includes a content storage database 206a that may store received digital content (e.g., the PDF files discussed below) provided to the content conversion server subsystem 200, an image storage database 206b that may store data associated with image elements extracted from the received digital content (e.g., the image elements and/or the HTML formatted image data discussed below), a text storage database 206c that may store data associated with text elements extracted from the received digital content (e.g., the text element and/or the HTML formatted text data discussed below), a metadata storage database 206d that may store metadata extracted from the received digital content (e.g., the text element location information and image element location information discussed below), and a machine learning database 206e that may store user actions on text elements and image elements extracted from the received digital content. While a plurality of specific databases have been illustrated and described, one of skill in the art in possession of the present disclosure will recognize that the databases in the content conversion server subsystem 200 may be combined (e.g., into a single database), split into two or more other databases, or provided in other formats (e.g., simple files on one or more disk drives) while remaining within the scope of the present disclosure.

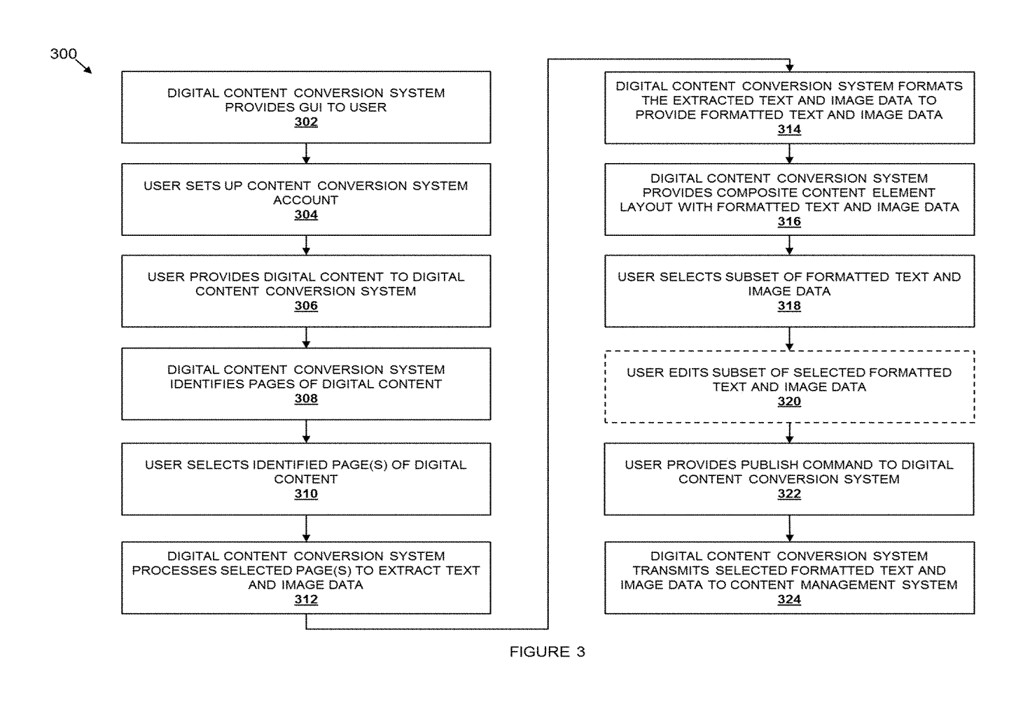

Referring now to FIG. 3, and embodiment of a method 300 for converting digital content for publishing is illustrated. As discussed below, the method 300 allows a user to provide digital content to the system to have that digital content converted to a composite content element layout that allows the user to select the content elements that they would like to publish to a content management system. While the user is described as manually selecting content elements from the composite content element layout, as discussed below any selections of content elements may be stored with previous selections from other users that have converted and published digital content and databases of those selections may be analyzed by a machine learning system to predict content element selections for future content that is converted and published. As such, while some embodiments of the method 300 provide for user selection of content elements, user editing of content elements, and/or other user actions to identify and modify the converted digital content that will be published, other embodiments may provide for the automatic recognition and modification of content elements for publishing.

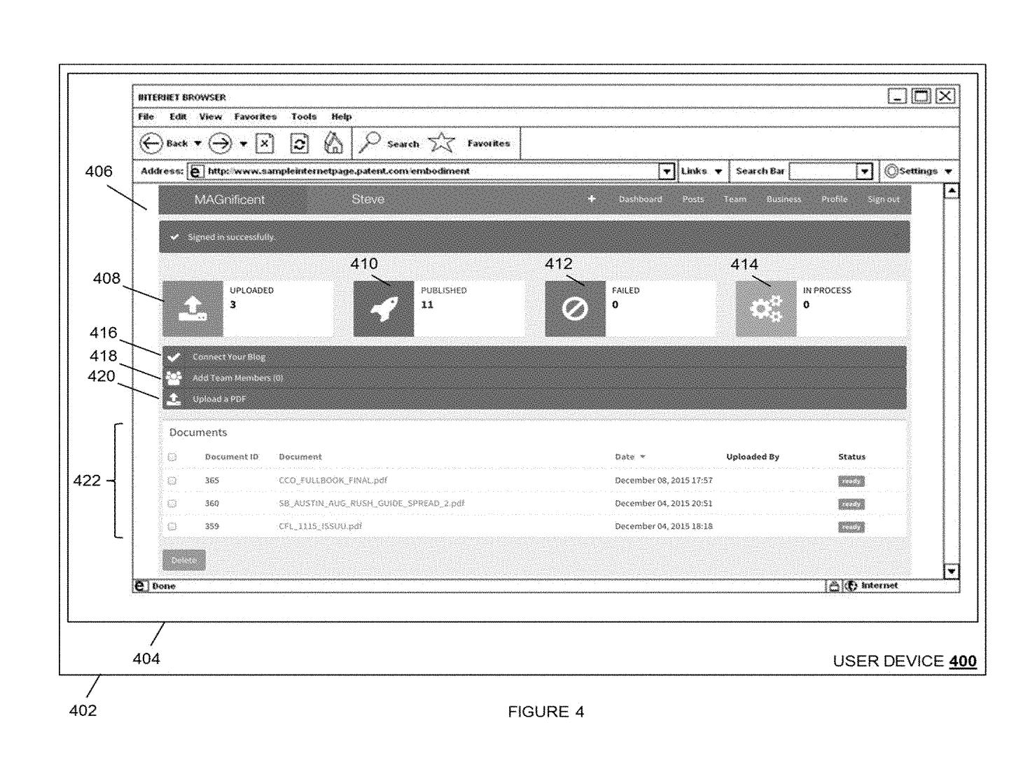

The method 300 begins at block 302 where the digital content conversion system provides a graphical user interface (GUI) to a user. Many of the figures discussed below illustrate a user device displaying different embodiments of a GUI that is described as provided over the network to a user device by the digital content conversion system 102. For example, FIG. 4 illustrates a user device 400, which may be any of the user devices 108a-e discussed above with reference to FIG. 1, that includes a chassis 402 housing a display device 404. In FIG. 4, the display device 404 is illustrated as displaying an embodiment of a dashboard portion 406 of the GUI that may be provided through the network 104 by the web server subsystem 102a in the digital content conversion system 102 and to the user device 400 for display via an Internet browser application, a mobile device application, a smart device application, and/or via any other computing system known in the art. In other words, the GUI discussed below may be provided by the digital content conversion system 102 as a web application that is accessible on the user device 400 via an Internet browser. However, in other embodiments, the digital content conversion system may instead be provided on the user device 400 for display as a stand-alone application. In other words, the GUI discussed below may be provided by the digital content conversion system that is a local application included on the user device 400. While a few specific examples have been provided, other manners for providing the GUI discussed below are envisioned as falling within the scope of the present disclosure as well.

The method 300 then proceeds to block 304 where the user sets up a content conversion system account with the content conversion system. As discussed above, the user device 400 is illustrated as displaying a dashboard portion 406 of a GUI, and in some embodiments access to the dashboard portion 406 of the GUI may be restricted to authorized/registered users of the digital content conversion system 102. As such, prior to the display of the dashboard portion 406 of the GUI, the user of the user device 400 may have provided authentication credentials (e.g., a username and password, a biometric authentication, etc.) to the digital content conversion system 102 in order to access the dashboard portion 406 of the GUI as illustrated in FIG. 4. In an embodiment, the dashboard portion 406 of the GUI provides a “control center” for the user of the digital content conversion system 102 that allows the user to review content that has been previously provided to the digital content conversion system 102, provide new content to the digital content conversion system 102, and/or perform other functionality discussed below.

For example, the dashboard portion 406 of the GUI includes a previous content indicator 408 that indicates a number of digital documents that have been previously provided to the digital content conversion system 102, a published content indicator 410 that indicates a number of publications that have been previously performed through the digital content conversion system 102, a failed content indicator 412 that indicates a number of failed publications that have failed to publish through the digital content conversion system 102, and a content progress indicator 414 that indicates the progress of a current publication through the digital content conversion system 102. The dashboard portion 406 of the GUI also includes a content management system connection element 416 that, as discussed below, allows a user to connect the digital content conversion system 102 to a blog content management system; a user addition element 416 that, as discussed below, allows a user to add other users as authorized users that may convert and publish content to the content management system (e.g., that was connected via the content management system connection element 416); and a digital document provisioning element 420 that, as discussed below, allows a user to upload a PDF file to the digital content conversion system 102 through the network 104.

The dashboard portion 406 of the GUI also includes a previously provided digital document section 422 that details digital documents that were previously provided (e.g., via the digital document provisioning element 420) to the digital content conversion system 102, including details such as, for example, document numbers, document names, document provisioning dates, identifiers for users that provided the digital documents, and the status of the document (i.e., whether the digital document is ready for publishing, discussed in further detail below). While a specific embodiment of the dashboard portion 406 of the GUI has been illustrated and described, one of skill in the art in possession of the present disclosure will recognize that the dashboard portion 406 may be provided with a variety of other features that will fall within the scope of the present disclosure.

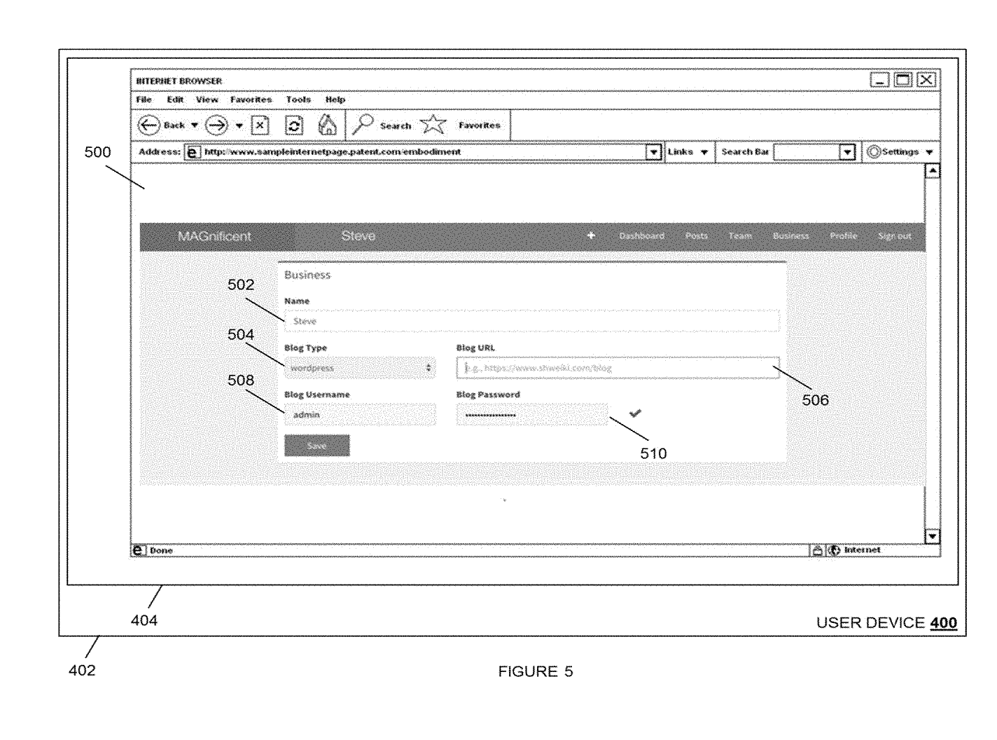

Referring now to FIG. 5, an embodiment of a content management system connection portion 500 of the GUI is illustrated as being displayed on the display device 404 of the user device 400. In an embodiment, the content management system connection portion 500 of the GUI may be provided through the network 104 by the web server subsystem 102a in the digital content conversion system 102 and to the user device 400 in response to the user selecting the content management system connection element 416 on the dashboard portion 406 of the GUI. In the illustrated example, the content management system connection portion 500 of the GUI includes a user name element 502 that is configured to receive a name of the user connecting the content management system to the digital content conversion system 102, a content management system type element 504 that is configured to receive a type of the content management system (e.g., a WordPress blog in the illustrated embodiment) that is being connected to the digital content conversion system 102, and a content management system address element 506 that is configured to receive an address of the content management system (e.g., a Universal Resource Locater (URL) in the illustrated embodiment) that is being connected to the digital content conversion system 102.

Furthermore, the content management system connection portion 500 of the GUI includes content management system authentication elements 508 and 510 that are configured to receive authentication credentials (e.g., a username and password in the illustrated embodiment) for the content management system that is being connected to the digital content conversion system 102 (and with which the user may have previously established an account as discussed above). At block 306, the user may provide the information discussed above into the elements 502-510, and that information may be used by the digital content conversion system 102 to connect to one of the content management systems 104. While a specific embodiment of the content management system connection portion 500 of the GUI has been illustrated and described, one of skill in the art in possession of the present disclosure will recognize that the content management system connection portion 500 may be provided with any elements necessary to provide for the connection to a variety of other types of content management systems while remaining within the scope of the present disclosure.

With reference back to FIG. 4, while not illustrated, in response to a selection of the user addition element 416 on the dashboard portion 406 of the GUI, a user may be presented with a user addition portion of the GUI that allows the user to add other users as authorized users that are allowed to publish to the content management system that was connected to the digital content conversion system 102 via the content management system connection portion 500 of the GUI. For example, the content management system connected to the digital content conversion system 102 via the content management system connection portion 500 of the GUI may be a blog, news website, shopping website, social network, and/or other content management system that is utilized by a company that includes a plurality of users that will use the digital content conversion system to convert and publish content to that content management system as discussed below, and thus each of those users may be defined and authorized to do so via the user addition element 416 on the dashboard portion 406 of the GUI (e.g., by an “administrator” user or other user with authorization to do so).

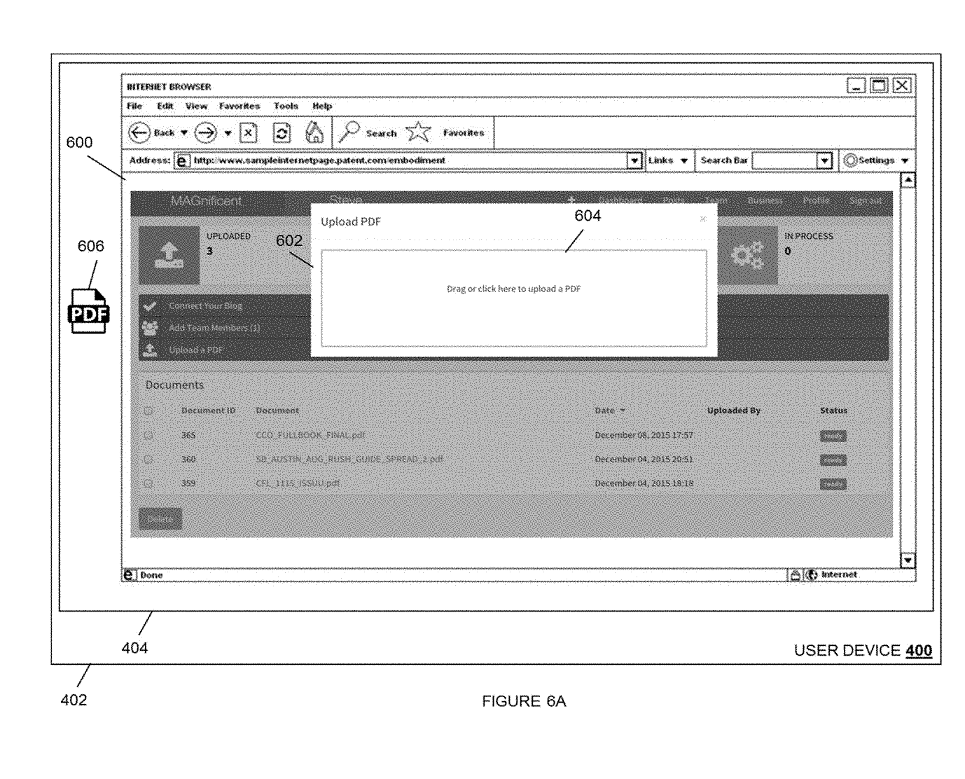

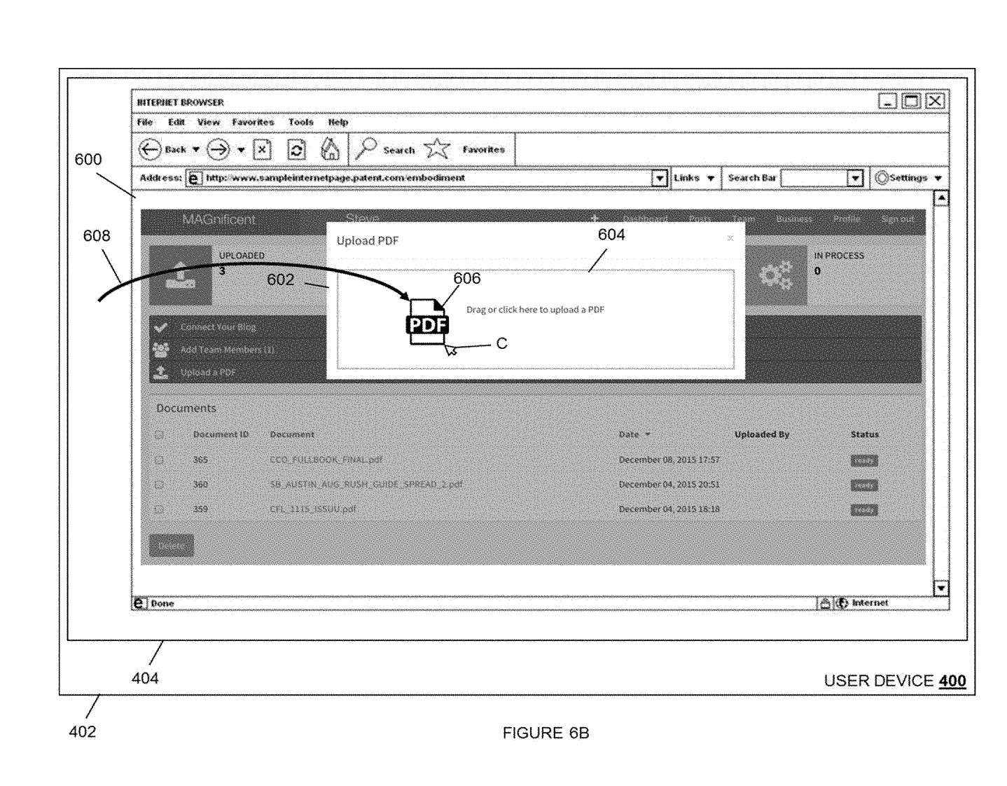

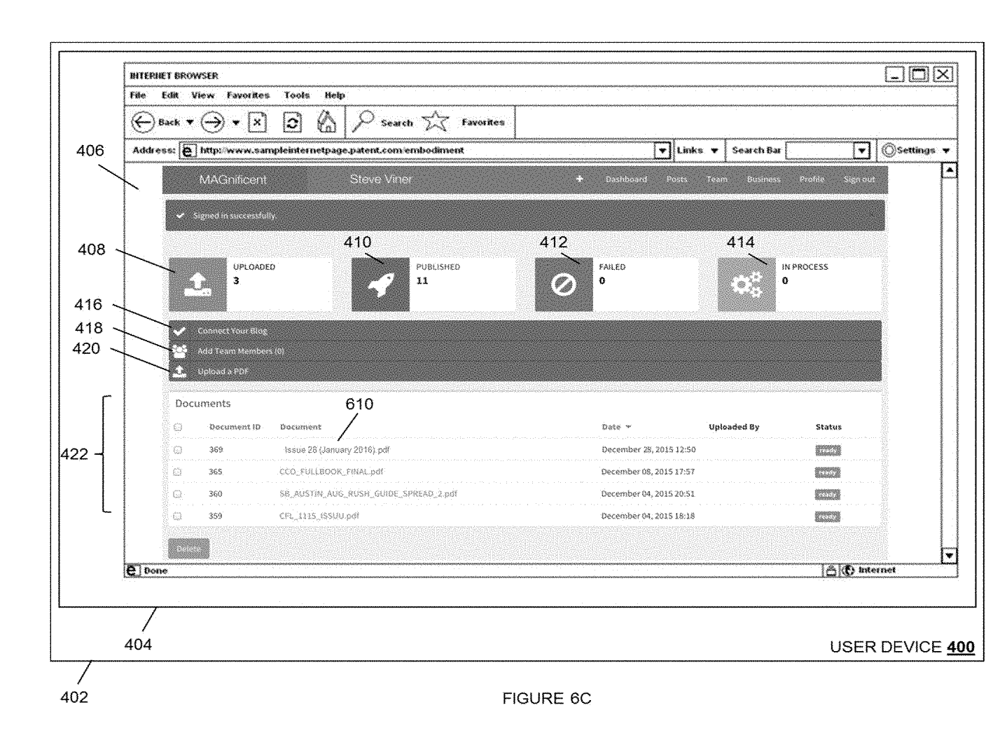

The method 300 then proceeds to block 306 where the user provides digital content to the digital content conversion system. Referring now to FIGS. 6A and 6B, an embodiment of a digital document provision portion 600 of the GUI is illustrated as being displayed on the display device 404 of the user device 400. In an embodiment, the digital document provision portion 600 of the GUI may be provided through the network 104 by the web server subsystem 102a in the digital content conversion system 102 and to the user device 400 in response to the user selecting the digital document provisioning element 420 on the dashboard portion 406 of the GUI. In the illustrated example, the digital document provision portion 600 of the GUI includes a digital document provisioning element 602 that is overlaid on the dashboard portion 406 of the GUI discussed above with reference to FIG. 4, and that includes a document provisioning window 604. In FIGS. 6A and 6B, the user device 400 is illustrated as displaying a digital document icon 606 (e.g., a PDF file icon representing a PDF file) on the desktop of the operating system adjacent the Internet browser in order to provide an example of digital document provisioning via the digital document provisioning element 602. However, one of skill in the art in possession of the present disclosure will recognize that other digital document provisioning techniques may be utilized (e.g., identifying a digital document in a file system explorer, providing an address to a digital document, etc.) while remaining within the scope of the present disclosure.

In an embodiment, at block 306, the user may utilized a cursor C to select the digital document icon 606 from the position illustrated in FIG. 6A and move the digital document icon 606 in a direction 608 from the desktop of the operating system adjacent the Internet browser to the an area within the document provisioning window 604, as illustrated in FIG. 6B. In response to deselecting the digital document icon 606 when it is positioned within the document provisioning window 604, the digital document associated with the digital document icon 608 will be transmitted through the network 104 to the digital document conversion system 102. For example, the PDF file may be transmitted through the network 104 to the web server subsystem 102a, and then provided by the web server subsystem 102a to the content conversion server subsystem 102b. In a specific example, the PDF file may be received through the communication device 206 from the web server subsystem 102a by the content conversion engine 204 in the content conversion server subsystem 200, and the content conversion server subsystem 200 may then store that PDF file (e.g., in its entirety) in the content storage database 206a. FIG. 6C illustrates the dashboard portion 406 of the GUI that has had the document section 422 updated with a digital document identifier 610 that identifies the digital document that was provided by the user to the digital content conversion system 102 at block 304.

As detailed above, in some embodiment, the digital document received at block 306 is a PDF file, which is a file format that is used to present documents in a manner that is independent of application software, hardware, and operating system, and that encapsulates a complete description of a fixed-layout flat document (including text, fonts, images/graphics, etc.) that is needed to display and/or print the content. In some example, the PDF file may include binary data or text data that provides PostScript printer commands for printing the information in the PDF file. As such, the techniques described herein will be beneficial (e.g., with only minor modifications that would be apparent to one of skill in the art in possession of the present disclosure) to other PostScript type document types such as Encapsulated PostScript (EPS), ADOBE® Illustrator drawing format (“.ai”), and/or other PostScript formats known in the art. However, while the illustrations and description below focus on the PostScript file formats, a variety of other types of documents may benefit from the teachings of the present disclosure as well (e.g., word processing file formats, spreadsheet file formats, etc.) Furthermore, the teachings of the present disclosure may utilize image and character recognition techniques on photos and/or other image documents in order to allow those documents to be converted and published in substantially the same manner that is described below for the PDF files. As such, any of a variety of digital documents may benefit from the teachings herein and thus are envisioned as falling within the scope of the present disclosure.

The method 300 then proceeds to block 308 where the digital content conversion system identifies pages of the digital content. In an embodiment, block 308 may be performed in response to the user selecting the digital document identifier 610 in the document section 422 illustrated in FIG. 6C. At block 308, the content conversion server subsystem 102b in the digital content conversion system 102 may identify pages of the digital content received at block 306. For example, at block 306, the content conversion engine 204 may retrieve the PDF file that was stored in the content storage database 206a, analyze that PDF file, and identify each page of the PDF file. In a specific example, at block 308, the content conversion engine 204 may extract each page of the PDF file as a separate PDF file. However, it has been found that the extraction of each page of the PDF file has a relatively large time and computation overhead, and thus may be undesirable except for relatively small (e.g., relatively low page number PDF files). As such, in another specific example, at block 308 the content conversion engine 204 may capture an image (e.g., a “thumbnail” image) of each page of the PDF file.

Furthermore, in some embodiments, the extraction of pages from the PDF file as separate PDF files or the capturing of images of pages of the PDF file may not need to be performed on each page of the PDF file. For example, the content conversion engine 204 may recognize some pages of the PDF file as being blank, including low value information (e.g., including advertisements), and/or otherwise categorized as pages that do not need identification at block 308. In a specific example, the content conversion engine 204 may reference the machine learning storage database 206e (and/or machine learning subsystems that utilize the data in the machine learning storage database 206e) in order to determine whether pages of the PDF file do not need identification at block 308. As such, the machine learning data retrieved during the method 300, discussed in further detail below, may enable the content conversion engine 204 to identify relevant pages of the PDF file (i.e., based on data that indicates what types, styles, content, and/or other characteristics have been included in pages selected in past performances of the method 300).

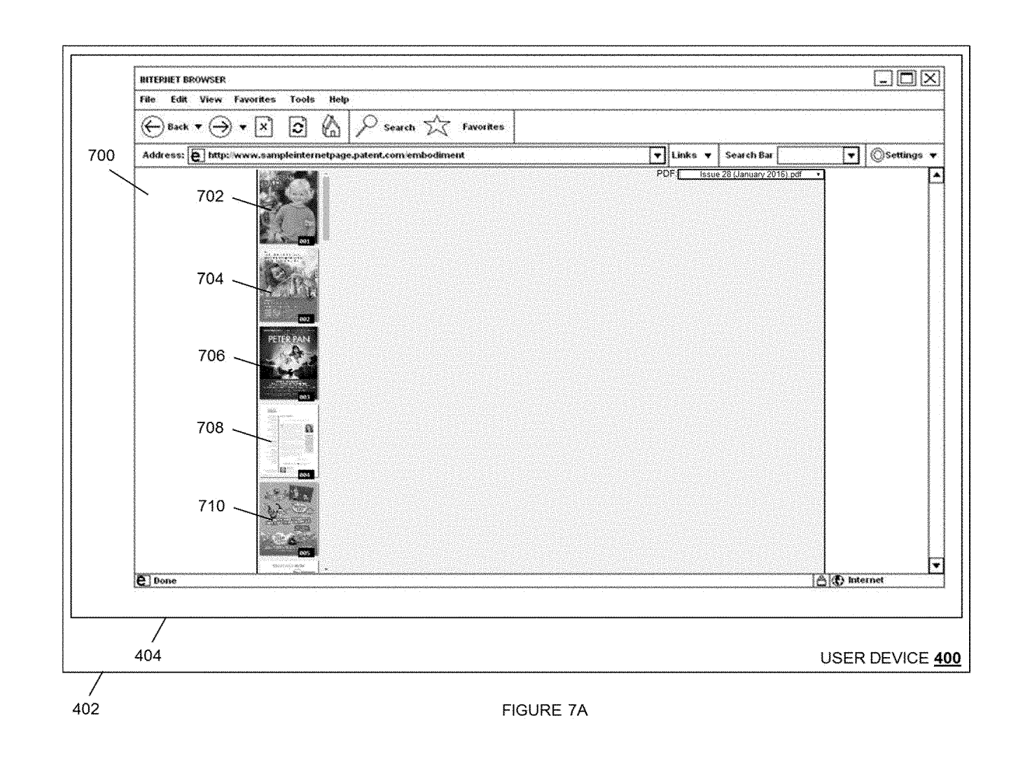

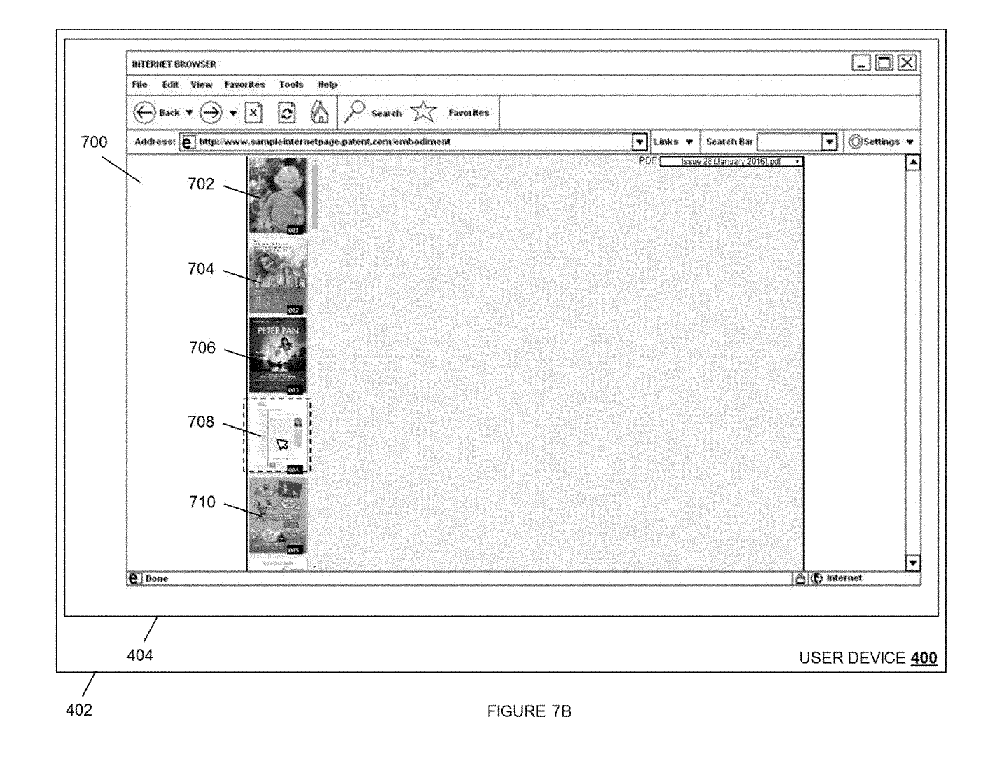

Referring now to FIGS. 7A and 7B, an embodiment of a page selection portion 700 of the GUI is illustrated as being displayed on the display device 404 of the user device 400. In an embodiment, the page selection portion 700 of the GUI may be provided through the network 104 by the web server subsystem 102a in the digital content conversion system 102 and to the user device 400 in response to the content conversion engine 204 completing its identification of at least one of the pages in the PDF file, and providing that identification to the web server subsystem 102a (e.g., the content conversion engine 204 may provide the web server subsystem 102a the images of the page(s) of the PDF file, the content conversion engine 204 may provide the web server subsystem 102a the single-page PDF files were extracted from the PDF file received at block 306, etc.) In the illustrated example, the page selection portion 700 of the GUI includes page identifiers 702, 704, 706, 708, and up to 710 for each page identified at block 308, and the page selection portion 700 may allow a user to scroll through each of the page identifiers for the pages identified at block 308 that are not visible in FIG. 7A. Furthermore, page identifier display configurations other than that illustrated in FIG. 7A may be utilized such as, for example, display of each of the page identifiers in a grid format (i.e., with page identifiers that fill the screen illustrated in FIG. 7A).

The method 300 then proceeds to block 310 where the user selects identified page(s) of the digital content. In an embodiment, the user may select one or more of the page identifiers 702-710 that were provided on the page selection portion 700 of the GUI in order to identify to the digital content conversion system 102 which of the identified pages of the PDF file should be converted as discussed below. Thus, while the examples below illustrate and describe the selection of a single page identified by a page identifier in the page selection portion 700 of the GUI, and the conversion of content included in that single page, the selection of multiple pages identified by respective page identifiers in the page selection portion 700 of the GUI, and the conversion of content included in those multiple pages will fall within the scope of the present disclosure. For example, FIG. 7B illustrates the user utilizing the cursor C to select the page identifier 708 on the page selection portion 700 of the GUI (e.g., indicated by the dashed line around the page identifier 708), but one of skill in the art in possession of the present disclosure will recognize that other techniques may be utilized (e.g., drawing a “box” around multiple page identifiers that may be, for example, pages common to a particular article) to select more than one page identifier at block 310. The selection of the page identifier 708 may be provided through the network 104 to the web server subsystem 102a, and from the web server subsystem 102a to the content conversion server subsystem 102b, at block 310.

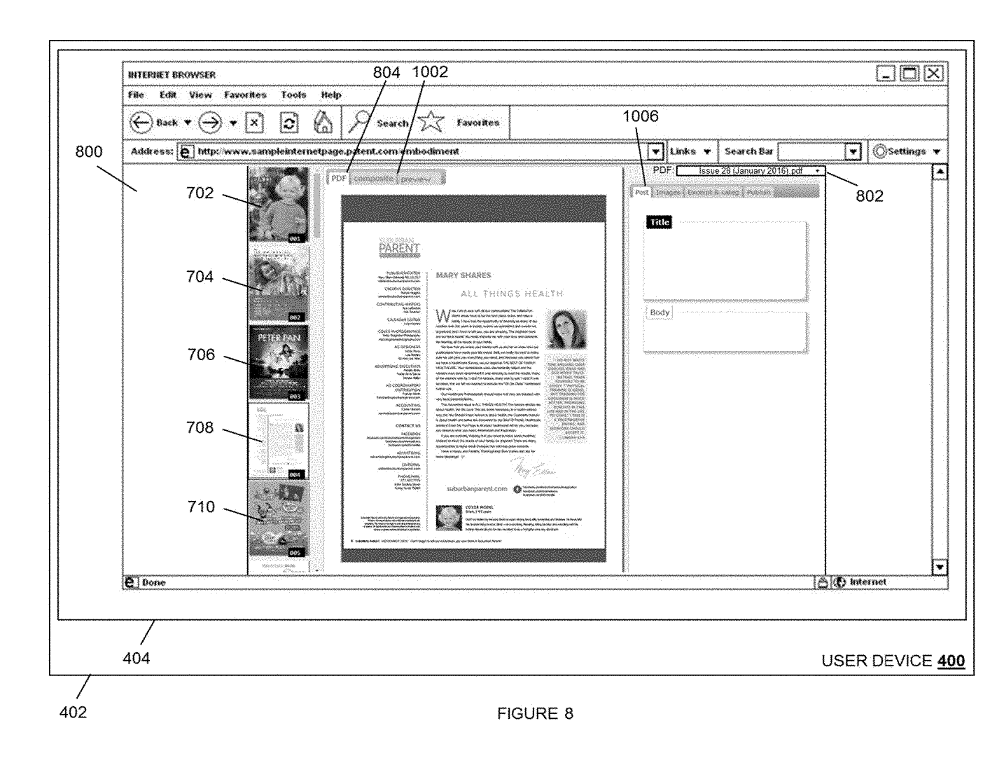

Referring now to FIG. 8, an embodiment of a page display portion 800 of the GUI is illustrated as being displayed on the display device 404 of the user device 400. In an embodiment, the page display portion 800 of the GUI may be provided through the network 104 by the web server subsystem 102a in the digital content conversion system 102 and to the user device 400 in response to the selection of the page identifier 708 on the page selection portion 700 of the GUI. In the illustrated example, the page display portion 800 of the GUI includes each of the page identifiers 702-710 that were provided on the page selection portion 700 of the GUI, as well as a digital document file identifier 802 that identifies the digital content that was provided at block 306, a page display window 804 that displays the identified page that was selected at block 310, and content elements details window 1006, discussed in further detail below.

In an embodiment, the page display window 804 that displays the identified page that was selected via the page identifier 708 is provided in response to the content conversion server subsystem 102b receiving the selection of the page identifier 708 and returning an extracted page of the PDF file that is identified by that page identifier 708 to the web server subsystem 102a for provision in the page display window 804. For example, as discussed above, in some embodiments the content conversion engine 204 may have extracted each page of the PDF file received at block 306 as a separate PDF file and stored them in content storage database 206a, and at block 310 may retrieve the extracted page (i.e., as its own PDF file) that is associated with the page identifier 708 and provide that extracted page to the webserver subsystem 102a for provisioning to the user device 400 in the page display window 804. However, it has been found that it is more efficient (particularly when relatively large (high page number) PDF files are received at block 306) for the content conversion engine 204 identify the page of the PDF file using an image as the page identifier 708, and then extract that page as a separate PDF file when the user accepts the page identifier 708 and provide that extracted page to the webserver subsystem 102a for provisioning to the user device 400 in the page display window 804. As such, the page display window 804 displays the actual page of the digital document (e.g., as an extracted page PDF file of the original multi-page PDF file that was received at block 306) that was selected by the user via the page identifier 708. One of skill in the art in possession of the present disclosure will recognize how multiple pages of the PDF file may be provided via the page display window 1002 (e.g., as a scrollable multi-page documents, a click-through multi-page documents etc.) while remaining within the scope of the present disclosure.

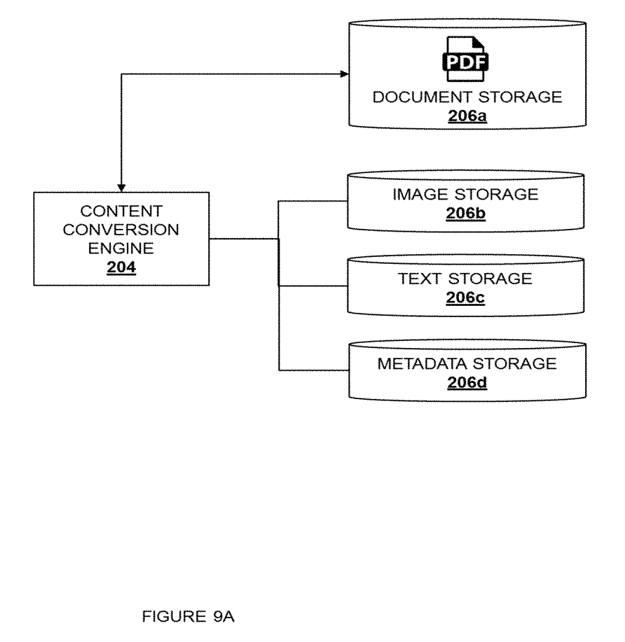

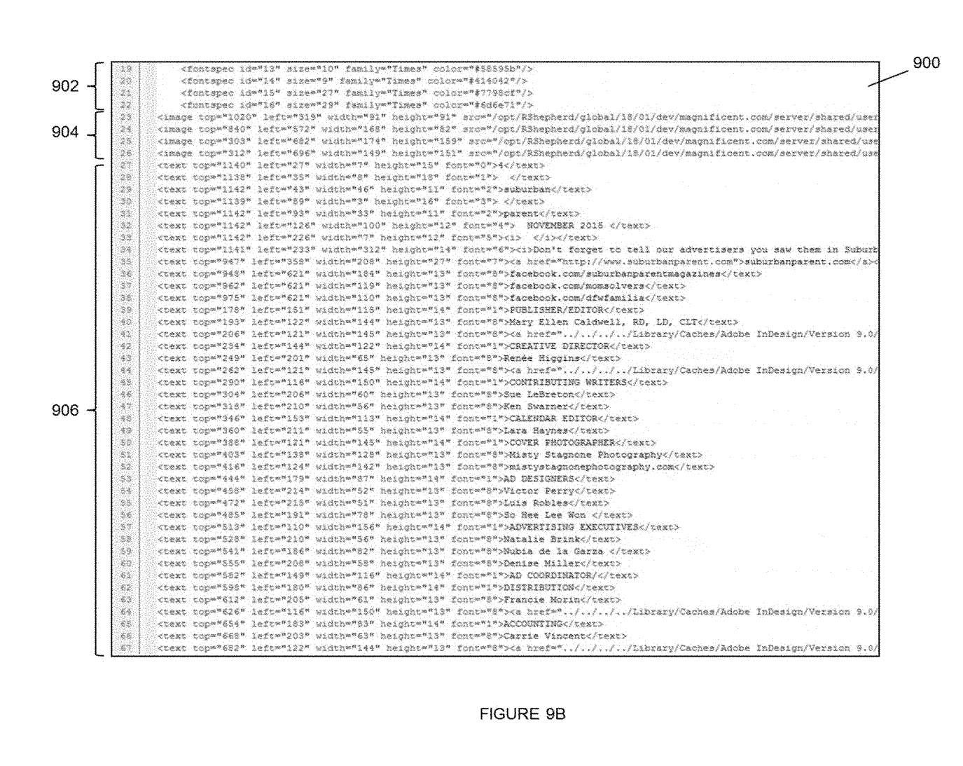

The method 300 then proceeds to block 312 where the digital content conversion system processes the selected page(s) to extract text data and image data. In an embodiment, with reference back to FIG. 8, the user may select a composite content element layout display window 1002 in order to initiate block 312. However, in other embodiments, block 312 may be performed upon the selection of the page identifier 708, upon receiving the PDF file at block 306, and/or at other times during the method 300. FIG. 9A illustrates how, at block 312, the content conversion engine 204 may retrieve the page of the digital document stored in the document storage database 206a. For example, the content conversion engine 204 may retrieve the page of the PDF file that was extracted from the PDF file as discussed above, and may operate to process that page of the PDF file to extract text elements, text element location information, image elements, image element information, other metadata, and/or any other information included in the page of the PDF file that may be utilized to perform the functionality discussed below.

Referring now to FIG. 9B, an embodiment of an extraction file 900 is illustrated that includes text elements, text element location information, image elements, image element location information, and other metadata that has been extracted from a page of the PDF file. In an embodiment, the content conversion engine 204 may process the text or binary data included in the page of the PDF file (discussed above) to extract the text elements, text element location information, image elements, image element location information, and other metadata and provide it in an Extensible Markup Language (XML) file. For example, the content conversion engine 204 may parse the page of the PDF file, recognize data in the page of the PDF file that is related to providing images or text in particular locations (e.g., via positioning instructions) of a printed document, and provide statements in the XML file that interpret that data as text elements, text element location information, image elements, image element location information, and other metadata information. Furthermore, content (e.g., text, images, etc.) may be stored inline inside the intermediate XML file, or referenced at locations in a storage device (e.g., files or database records) that are accessible by the system. While illustrated and described herein as an XML file, the extraction file 900 may be provided using a variety of other file types that that are configured to store the information discussed below and that would be apparent to one of skill in the art in possession of the present disclosure.

FIG. 9B illustrates the extraction file 900 having metadata section 902, an image section 904, and a text section 906. As such, the raw binary (or text) data in the page of the PDF file may be converted to an XML format in an XML file that identifies each of the plurality of text elements and their text element location information in the text section 906, each of the image element(s) and their image element location information in the image section 904, and the metadata in the metadata section 902. As can be seen in the specific example of FIG. 9B, the statements in the metadata section 902 define a font (i.e., the “<fontspec” statements with “id”, “size”, “family”, and “color”), the statements in the image section 904 identify image elements(s) and their image element locations on storage devices (e.g., the “<image” statements with “top”, “left”, “width”, “height”, and “src”), and the statements in the text section 906 identify text elements and their text element location in the extraction file itself (e.g., the “<text” statements with “top”, “left”, “width”, “height”, “font”, and the actual text to be displayed.) While a specific processing technique for processing the PDF file to extract text and image elements, their associated location information, and other metadata into an XML file has been described, one of skill in the art in possession of the present disclosure will recognize that other digital documents may require other types of techniques to perform the text and image element extraction that will still fall within the scope of the present disclosure. For example, the image and optical character recognition discussed above may be performed at block 312 on image documents while remaining within the scope of the present disclosure.

Referring back to FIG. 9A, in some embodiments, the content conversion engine 204 may store extracted image elements, extracted text elements, and extracted metadata in the image storage database 206b, the text storage database 206c, and the metadata storage database 206d. For example, the content conversion engine 204 may store extracted image elements and image location information in association with the page of the PDF file (e.g., from which it was extracted) in the image storage 206b, extracted text elements and text element location information in association with the page of the PDF file (e.g., from which it was extracted) in the text storage 206c, and extracted metadata in association with the page of the PDF file (e.g., from which it was extracted) in the metadata storage 206d. However, in other embodiments, the XML file (e.g., the extraction file 900) with the text elements, text location information, image elements, image location information, and metadata may be stored in association with the page of the PDF file (e.g., from which it was generated) in any database.

The method 300 then proceeds to block 314 where the digital content conversion system formats the extracted text and image data to provide formatted text and image data. In an embodiment, at block 314, the content conversion engine 204 in the digital content conversion system 200 may format the text elements using their associated text element location information to provide formatted text elements, and format the image elements using their associated image element location information to provide formatted image elements. In a specific example, the formatting of the text elements at block 314 may include the content conversion engine 204 processing the XML file 900 to convert the statements in the text section 906 that identify the text elements and their text element location information to HTML formatted text data, while the formatting of the image elements at block 314 may include the content conversion engine 204 processing the XML file 900 to convert the statements in the image section 904 that identify the image elements and their image element location information to HTML formatted image data. In another specific example, position in absolute pixels may be converted to a percentage of the viewport (e.g., the page) size, which may provide for scalability of the text (e.g., via a “zoom” function).

In an embodiment, the HTML formatted text data may organize the text elements identified in the text section 906 of the XML file 900 into one or more discrete objects that a human recognizes as a visual design text element such as a paragraph, a header, a title, snaking columns of text, articles across multiple pages, drop caps, first line indents, and/or other text elements known in the art. Similarly, the HTML formatted image data may organize the image elements identified in the image section 904 of the XML file 900 into objects that a human recognizes as a visual design image element such as a graph, an author's portrait, a signature, and/or other image elements known in the art. Sets of images may also be recognized as belonging together. For example, a border image that is provided around an author's portrait, a mask that renders part of an image invisible or translucent, or background images that provide a desired look to the page.

Furthermore, text and image elements included in the page of the PDF file may be recognized and discarded (i.e., not formatted to provide a portion of the HTML formatted text or image data) such as, for example, page numbers, reoccurring titles or banners, advertising images, and image masks. Each of the text elements and image elements formatted at block 314 may be recognizable by their position on the page of the PDF, their size, their shape, and/or other characteristics that give some indication as to the relative value of those text and image elements, and each of those characteristics may be preserved during the extraction of the text elements and image elements from the PDF file and used to create the HTML formatted text and image data. As discussed above, data in the machine learning storage database 206e may be utilized to determine which text elements and image elements to format at block 314.

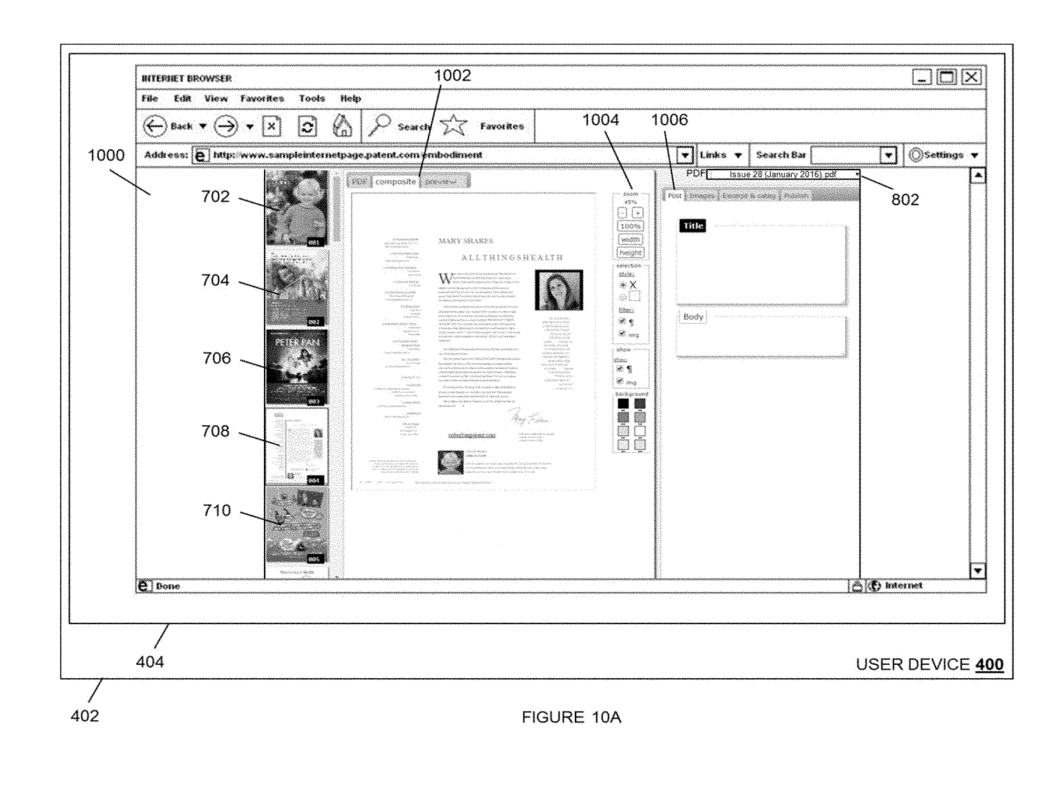

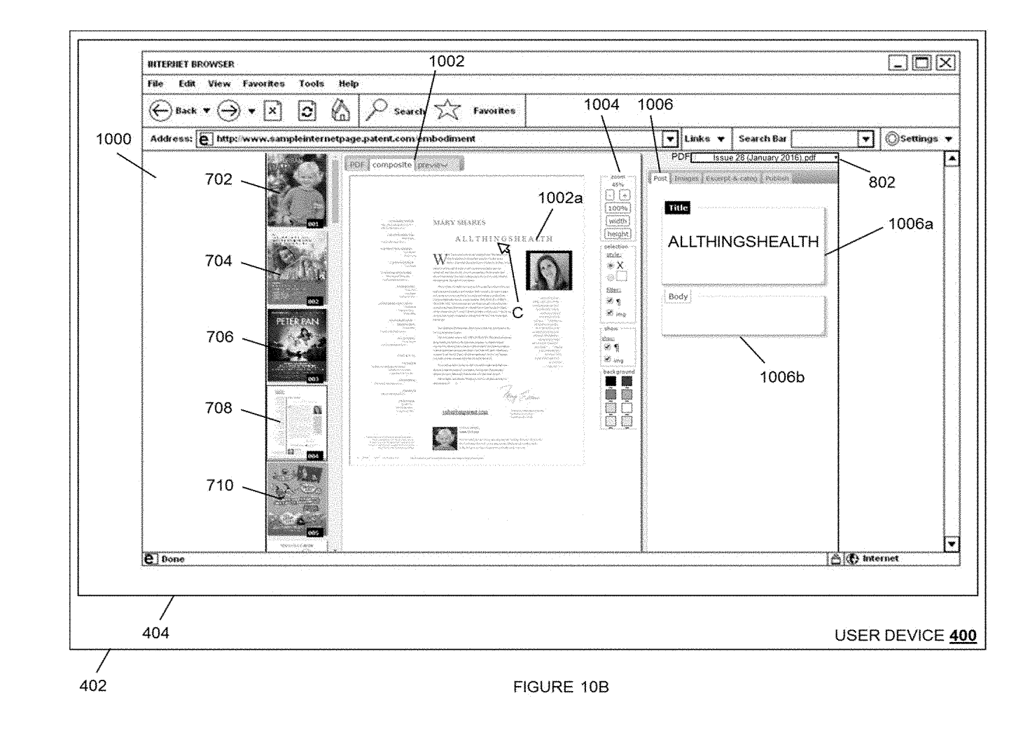

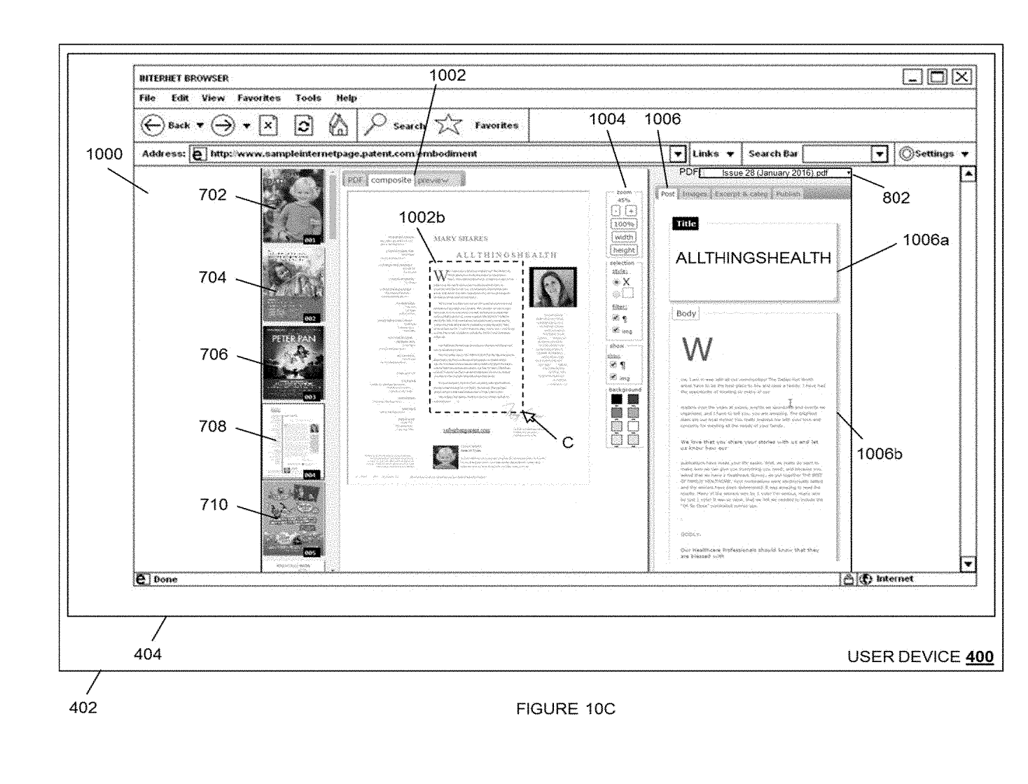

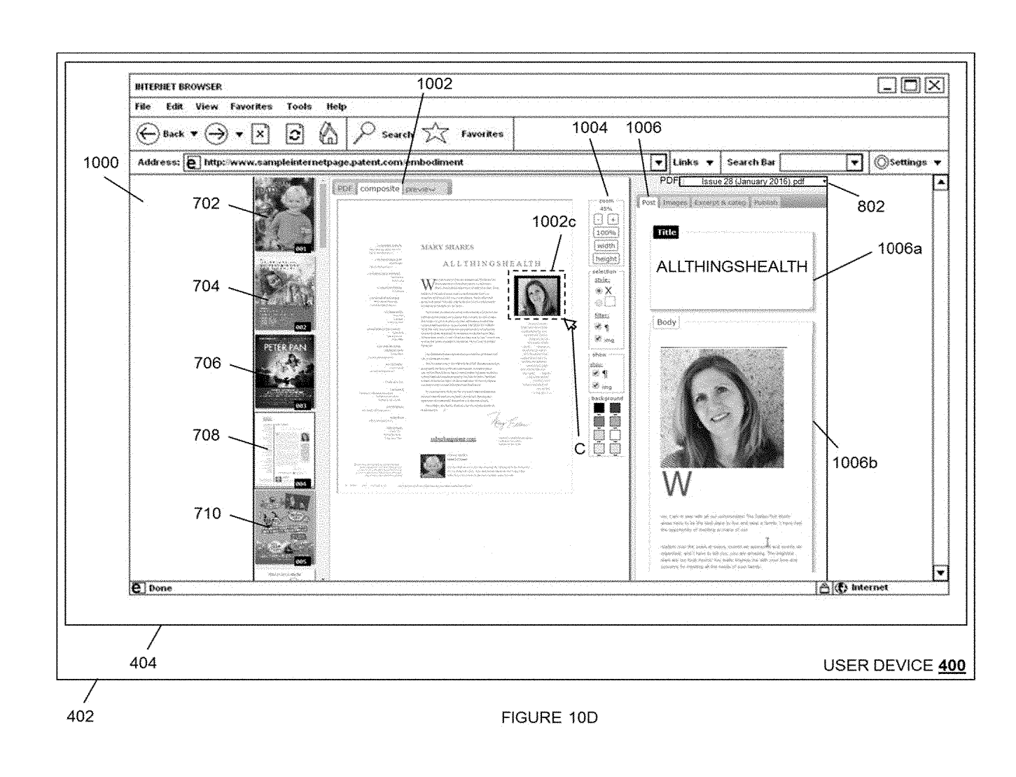

The method 300 then proceeds to block 316 where the digital content conversion system provides a composite content element layout with the formatted text and image data. As illustrated and discussed below, block 316 provides a composite content element layout with formatted text and image data that preserves the identification of visual design elements that were present in the original document (e.g., the PDF file discussed above). Referring now to FIG. 10A, an embodiment of a composite content element layout display portion 1000 of the GUI is illustrated as being displayed on the display device 404 of the user device 400. In an embodiment, the composite content element layout display portion 1000 of the GUI may be provided through the network 104 by the web server subsystem 102a in the digital content conversion system 102 and to the user device 400 in response to the digital content server subsystem 102b providing the HTML formatted text data and HTML formatted image data to the web server subsystem 102a for provision as the composite content element layout in the composite content element layout display window 1002. In the illustrated example, the composite content element layout display portion 1000 of the GUI includes each of the page identifiers 702-710 that were provided on the page selection portion 700 of the GUI, as well as the digital document file identifier 802 that identifies the digital content that was provided at block 306, the composite content element layout display window 1002 that displays a composite content element layout, and content elements details window 1006, discussed in further detail below.

In an embodiment, the composite content element layout in the composite content element layout display window 1002 includes the HTML formatted text data and the HTML formatted image data. For example, the HTML formatted text data may provide each word, line, or other section of the text that was extracted from the page of the PDF file in a relative location in the composite content element layout that was defined by the text element location information that was associated with that word, line, or other section of text. In another example, the HTML formatted text data may provide groupings of words of the text (e.g., paragraphs, a title, an author name, a side bar, a footnote, etc.) that was extracted from the page of the PDF file in a relative location in the composite content element layout that was defined by the text element location information that was associated with that grouping of text. As such, the composite content element layout in the composite content element layout display window 1002 provides the text elements that were extracted from the page of the PDF file in substantially similar relative locations as they were in that page of the PDF file (as can be seen by a comparison of the composite content element layout in the composite content element layout display window 1002 in FIG. 10A and the page of the PDF file in the page display window 804 of FIG. 8). As discussed below, the provisioning of the HTML formatted text data in the composite content element layout allows for the separate selection of any word or letter included in the HTML formatted text data, as well as grouped selection of multiple words or letters included in the HTML formatted text data.

In another example, the HTML formatted image data may provide each image of the images that were extracted from the page of the PDF file in a relative location in the composite content element layout that was defined by the image element location information that was associated with those images. As such, the composite content element layout in the composite content element layout display window 1002 provides the image elements that were extracted from the page of the PDF file in substantially similar relative locations as they were in that page of the PDF file (as can be seen by a comparison of the composite content element layout in the composite content element layout display window 1002 in FIG. 10A and the page of the PDF file in the page display window 804 of FIG. 8).

As can be seen by the comparison of the composite content element layout in the composite content element layout display window 1002 in FIG. 10A and the page of the PDF file in the page display window 804 of FIG. 8, some elements included in the page of the PDF file are not provided in the composite content element layout in the composite content element layout display window 1002. This comparison illustrates how the content conversion engine 204 may recognize “low value” text and image elements (e.g., borders, page numbers, visual design elements) in the page of the PDF file and discard those elements when creating the composite content element layout.

Furthermore, the composite content element layout display window 1002 also provides a display editor tool 1004 that allows the user to modify how the composite content element layout is displayed in the composite content element layout display window 1002. For example, the user may utilize the display editor tool 1004 to modify the size or dimensions of the composite content element layout, selectively display text or images alone, add or remove a grid in the background, change background color to make text in different colors visible, hide identified element types (e.g., page numbers, headers, advertising), and/or modify a variety of other display characteristics of the composite content element layout

The method 300 then proceeds to block 318 where the user selects a subset of the formatted text and image data. In an embodiment, at block 318, the user may select any of the HTML formatted text data and/or the HTML formatted image data provided in the composite content element layout, and the content element layout display portion 1000 includes the content elements details window 1006 that, in the illustrated embodiment, includes a title section 1006a and a body section 1006b that are configured to display selected HTML formatted text and/or images. Referring to FIG. 10B, an embodiment of the content element layout display portion 1000 of the GUI is provided that illustrates a user selecting an HTML formatted text element 1002a in the composite content element layout after selecting the title section 1006a of the content elements details window 1006.

For example, FIG. 10B illustrates the user using the cursor C to select the HTML formatted text element 1002a (a title of an article “ALL THINGS HEALTH” in the illustrated embodiment). In response to that selection (e.g., a “click” or “tap”), the HTML formatted text element 1002a may then be displayed in the selected section of the content elements details window 1006 (e.g., the title section 1006a in the illustrated embodiment). As such, a user attempting to convert and publish content may generate the composite content element layout as discussed above, select the title section 1006a of the content elements details window 1006, and then select the HTML formatted text element in the composite content element layout that corresponds to the title of the content in order to have that HTML formatted text element displayed in the title section 1006a. Furthermore, as the data of users selections of titles for the title section 1006a of the content elements details window 1006 is compiled over many performances of the method 300, the content conversion engine 204 may utilize that data to recognize likely text element(s) that provide a title of the content, and may automatically populate the title section 1006a of the content elements details window 1006 with those text element(s).

In another example, FIG. 10C illustrates the user using the cursor C to select the HTML formatted text element(s) 1002b (a body of an article in the illustrated embodiment) following a selection of the body section 1006b of the content elements details window 1006. In response to that selection (e.g., a “window draw” or “selection box”), the HTML formatted text element(s) 1002b may then be displayed in the selected section of the content elements details window 1006 (e.g., the body section 1006b in the illustrated embodiment). As such, a user attempting to convert and publish content may generate the composite content element layout as discussed above, select the body section 1006b of the content elements details window 1006, and then select the HTML formatted text element in the composite content element layout that corresponds to the body of the content in order to have that HTML formatted text element(s) displayed in the body section 1006b. Furthermore, the user may select multiple different sections of the HTML formatted text elements (e.g., from a single page or multiple pages of the PDF file converted to the composite content element layout) to have those HTML formatted text elements displayed in the body section 1006b. Further still, as the data of user selections of text elements for the body section 1006b of the content elements details window 1006 is compiled over many performances of the method 300, the content conversion engine 204 may utilize that data to recognize that likely text element(s) that provide a body of the content, and may automatically populate the body section 1006b of the content elements details window 1006 with those text element(s).

In another example, FIG. 10D illustrates the user using the cursor C to select the HTML formatted image element 1002c (an author portrait in an article in the illustrated embodiment) following a selection of the body section 1006b of the content elements details window 1006. In response to that selection (e.g., a “window draw”, a “click”, a “tap”), the HTML formatted image element 1002c may then be displayed in the selected section of the content elements details window 1006 (e.g., the body section 1006b in the illustrated embodiment). As such, a user attempting to convert and publish content may generate the composite content element layout as discussed above, select a portion of the body section 1006b of the content elements details window 1006 (e.g., above the HTML formatted text elements populated in the body section 1006b as illustrated, between HTML formatted text elements populated in the body section 1006b, etc.), and then select the HTML formatted image element in the composite content element layout that corresponds to an image in the content in order to have that HTML formatted image element displayed in the selection portion of the body section 1006b. Furthermore, as the data of users selections of images for the body section 1006b of the content elements details window 1006 is compiled over many performances of the method 300, the content conversion engine 204 may utilize that data to recognize image element(s) that are likely to be selected for the body section 1006b, and may automatically populate the body section 1006b of the content elements details window 1006 with those image element(s).

In some embodiments, in addition to enabling the selection of HTML formatted image elements and their provisioning and display in the content elements details window 1006, the content element layout display portion 1000 of the GUI may allow the user to provide images from a variety of other sources. For example, GUI elements may be provided that allow the user to upload images stored on the user device 400 and/or accessible through the network (e.g., previously uploaded images in an image library, stock images available from image provisioning systems, etc.) Similarly, UI elements may be provided that allow the user to provide web links, media (e.g., videos, music, etc.), and/or any other content management system HTML elements that would be apparent to one of skill in the art in possession of the present disclosure. As such, digital content may be converted from the PDF file as discussed above, and then be supplemented with any other content (e.g., other images, text, media, etc.) as desired by the user.

While a few specific examples have been provided of the selection of HTML formatted text and image elements in the composite content element layout and their display in the content elements details window 1006, a wide variety of modification is envisioned as falling within the scope of the present disclosure. For example, the content elements details window 1006 illustrated and described above provides a content input format that may be specific to a particular content management system (i.e., as illustrated below, the content elements details window 1006 provides for the conversion of content to a single column, “title/body” format of a blog content management system). However, content management systems may define their content provisioning format in any of a variety of manners, some of which may be user-configurable. One of skill in the art in possession of the present disclosure will recognize how the content elements details window 1006 may provide any content input format required by a content management system so that the user can select text elements and image elements for provisioning to that content management system in order to provide the content in content input formats in substantially that same manner as discussed above.

Furthermore, the digital content conversion system 102 may allow a user to manipulate a content input format required by a content management system in order to provide content through that content management system in a format desired by a user (but not explicitly enabled by the content management system.) For example, the content elements details window 1006 may enable a user to designate HTML formatted text elements and/or image for display in a multi-column orientation when the content management system provides a single column content image format, and the digital content conversion system 102 may then insert HTML formatting elements into the HTML formatted text elements and/or image provided to the content management system so that the content management system will display those HTML formatted text elements and/or image in a multi-column orientation (e.g., by breaking the HTML formatted text elements up and providing them in the single column content input format such that they appear to a user reading the content as being provided in multiple columns, or using multi-column display capabilities in the Internet browser). As such, the digital content conversion system 102 may be configured to manipulated converted text and image elements in a manner that “tricks” the content management system into displaying content in a manner desired by the user that may not be explicitly enabled by the content management system.

The method 300 then proceeds to optional block 320 where the user edits the selected formatted text and image data. In an embodiment, following any selection of HTML formatted text data and HTML formatted image data, the user may edit the selected HTML formatted text data or HTML formatted image data. For example, with reference to FIG. 10B, the user may edit the HTML formatted text data provided in the title section 1006a of the content elements details window 1006 to, for example, modify the title, modify the font of the title, modify the size of the title, and/or perform any other text edits known in the art. In another example, with reference to FIG. 10C, the user may edit the HTML formatted text data provided in the body section 1006a of the content elements details window 1006 to, for example, modify the body, modify the font of the body, modify the size of the body, merge paragraphs, and/or perform any other text edits known in the art. In another example, with reference to FIG. 10D, the user may edit the HTML formatted image data provided in the body section 1006b of the content elements details window 1006 to, for example, modify the display of the image (e.g., color, brightness, etc.), modify the location of the image (e.g., move the image to the bottom of the body), modify the size of the image, crop the image, and/or perform any other image edits known in the art. As such, the users may provide any of the content in the PDF file in the composite content element layout (including content from multiple pages of the PDF file), select any of the HTML formatted text or image data generated from that content for provision in the content elements details window 1006, and then edit, order, and otherwise define how that content will be presented for display via modifications made to the HTML formatted text and image data displayed in the content elements details window 1006.

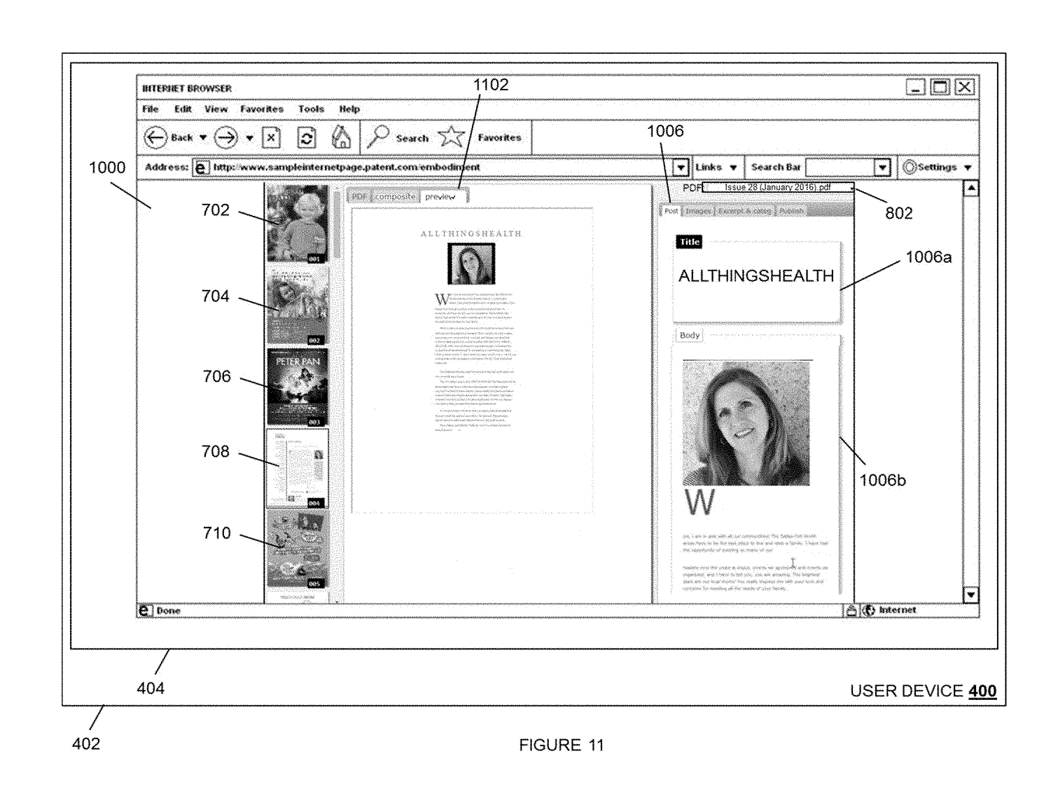

Referring now to FIG. 11, an embodiment of a preview portion 1100 of the GUI is illustrated as being displayed on the display device 404 of the user device 400. In an embodiment, the preview portion 1100 of the GUI may be provided through the network 104 by the web server subsystem 102a in the digital content conversion system 102 and to the user device 400 in response to the selection of a preview window 1102 on the page display portion 800 of the GUI. In the illustrated example, the preview portion 1100 of the GUI includes each of the page identifiers 702-710 that were provided on the page selection portion 700 of the GUI, as well as a digital document file identifier 802 that identifies the digital content that was provided at block 306, the preview window 1102 that displays a preview of the HTML formatted text and image data, and the content elements details window 1006, discussed above.

In an embodiment, the user may select the preview window 1102 at any time following the provisioning of the composite content element layout in the composite content element layout display window 1002. In response to a selection of the preview window 1102, the content conversion system 102 may provide any currently selected HTML formatted text and image data that is displayed in the content elements details window 1006 to the content management system 104 (e.g., in the content input format discussed above), and receive back from that content management system 104 a preview that displays how that currently selected HTML formatted text and image data will be displayed by the content management system when published. As such, the content conversion system 102 may send information about the currently selected HTML formatted text and image data that is displayed in the content elements details window 1006, including any modifications or edits made by the user, to the content management systems for creating the preview. Thus, when converting content for publishing, the user may be provided a dynamically updated preview of how the content will look when published on the content management system.

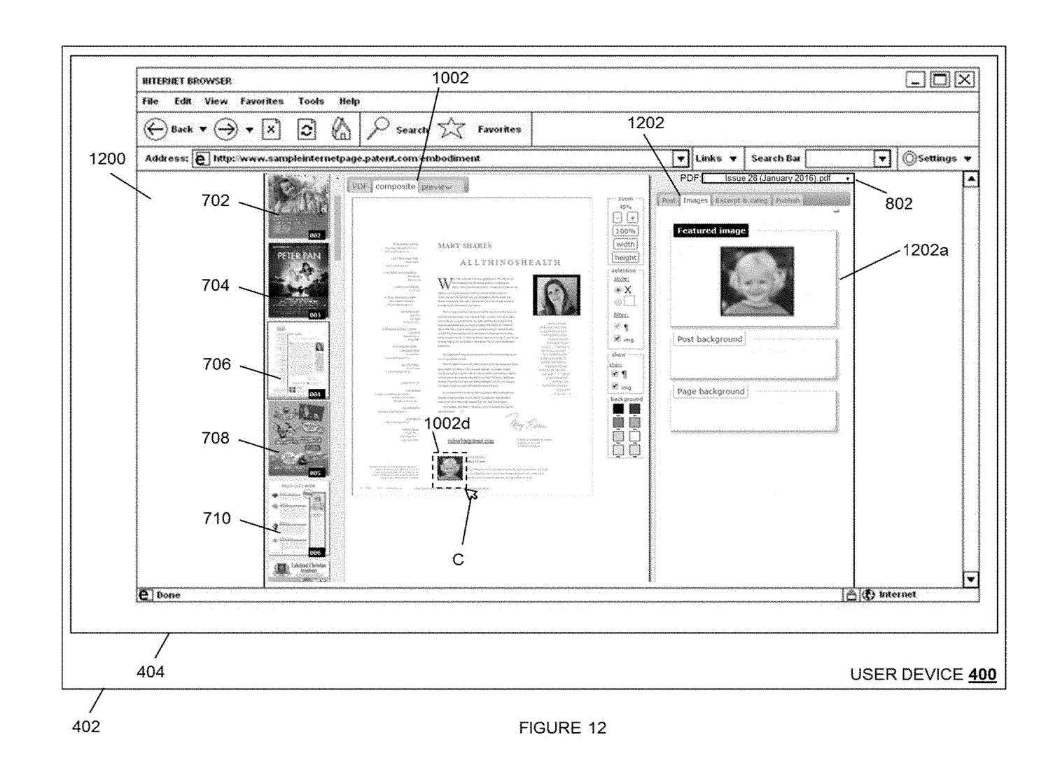

Referring now to FIG. 12, an embodiment of a content summary portion 1200 of the GUI is illustrated as being displayed on the display device 404 of the user device 400. In an embodiment, the summary portion 1200 of the GUI may be provided through the network 104 by the web server subsystem 102a in the digital content conversion system 102 and to the user device 400 in response to the selection of a content summary window 1202 on the summary portion 1200 of the GUI. In the illustrated example, the summary portion 1200 of the GUI includes each of the page identifiers 702-710 that were provided on the page selection portion 700 of the GUI, as well as a digital document file identifier 802 that identifies the digital content that was provided at block 306, and the summary window 1202 that includes a feature image section 1202a that allow a content summary image to be designated as discussed below, as well as a post background section 1202b and a page background section 1202c that all content backgrounds to be identified.

FIG. 12 illustrates the user using the cursor C to select the HTML formatted image element 1002d (an image in an article in the illustrated embodiment). In response to that selection (e.g., a “window draw”, a “click”, a “tap”), the HTML formatted image element 1002d may then be displayed in the content summary window 1202 (e.g., the feature image section 1202a in the illustrated embodiment). As such, a user attempting to convert and publish content may generate the composite content element layout as discussed above, select the feature image section 1202a of the content summary window 1202, and then select the HTML formatted image element in the composite content element layout in order to have that HTML formatted image element displayed in the feature image section 1202a (e.g., for provision as part of a content summary on the content management system 104).

Furthermore, as the data of users selections of images for the feature image section 1202a of the content summary window 1202 is compiled over many performances of the method 300, the content conversion engine 204 may utilize that data to recognize image element(s) that are likely to be selected for the feature image section 1202a, and may automatically populate the feature image section 1202a of the content summary window 1202 with those image element(s).

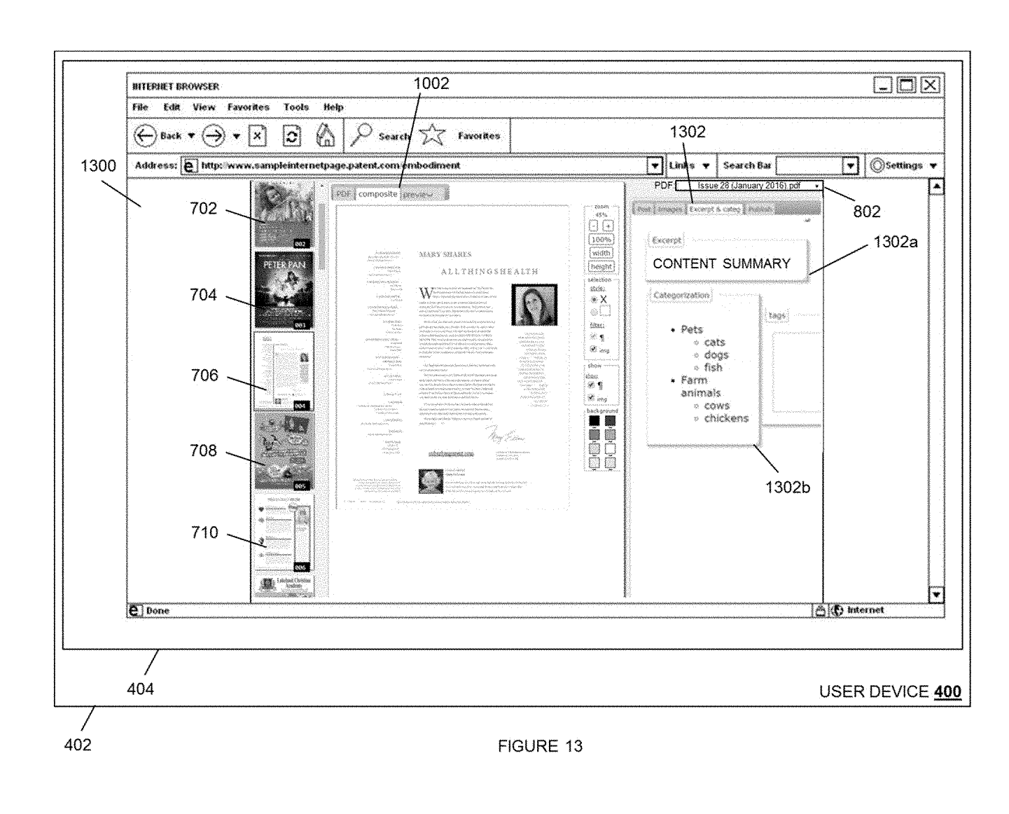

Referring now to FIG. 13, an embodiment of an excerpt and categorization portion 1300 of the GUI is illustrated as being displayed on the display device 404 of the user device 400. In an embodiment, the excerpt and categorization portion 1300 of the GUI may be provided through the network 104 by the web server subsystem 102a in the digital content conversion system 102 and to the user device 400 in response to the selection of an excerpt and categorization window 1302 on the excerpt and categorization portion 1300 of the GUI. In the illustrated example, the excerpt and categorization portion 1300 of the GUI includes each of the page identifiers 702-710 that were provided on the page selection portion 700 of the GUI, as well as a digital document file identifier 802 that identifies the digital content that was provided at block 306, and the excerpt and categorization window 1302 that includes an excerpt input 1302a, and a categorization input 1302b.

FIG. 13 illustrated how the user may provide a textual content summary in the excerpt input 1302a. While the textual summary is illustrated as input by the user, in other embodiments, the content summary may be provided by selecting HTML formatted text data similarly as discussed above. In an embodiment, the categorization input 1302b information may be retrieved by the digital content conversion system 102 from the content management system 104, and the user may provide categorization information via the categorization input 1302b in order to have the content management system 104 categorize the content that will be published.

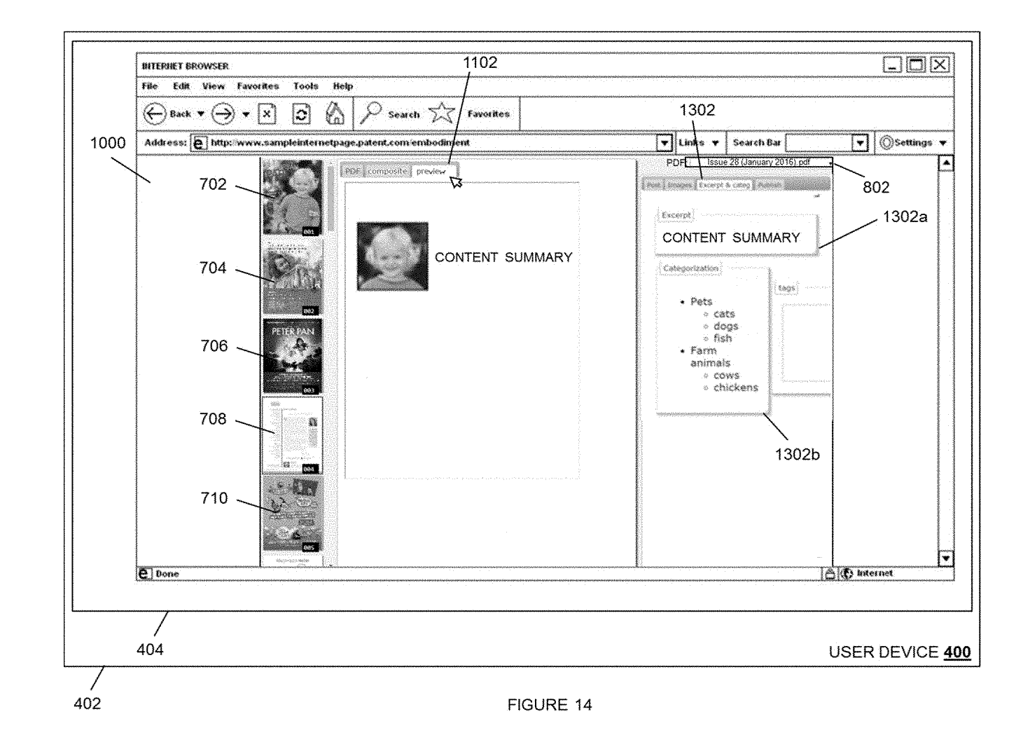

Referring now to FIG. 14, an embodiment of the preview portion 1100 of the GUI is illustrated as being displayed on the display device 404 of the user device 400. In an embodiment, the preview portion 1100 of the GUI may be provided through the network 104 by the web server subsystem 102a in the digital content conversion system 102 and to the user device 400 in response to the selection of a preview window 1102 on the page display portion 800 of the GUI. In an embodiment, the user may select the preview window 1102 following the provisioning of the HTML formatted image data in the feature image window 1202a, and the content summary in the except input 1302a. In response to a selection of the preview window 1102, the content conversion system 102 may provide any currently selected HTML formatted image data that was displayed in the feature image window 1202a, and the content summary that was provided in the except input 1302a, to the content management system 104 of the user, and receive back from that content management system 104 a preview that displays how that currently selected HTML formatted image data and content summary will be displayed by the content management system 104 when published. As such, the content conversion system 102 may send information about the currently selected HTML formatted image data and content summaries that are displayed in the summary window 1202 and excerpt and categorization window 1302, including any modifications or edits made by the user, to the content management systems for creating the preview. Thus, when converting content for publishing, the user may be provided a dynamically updating preview of how the content summary will look when published on the content management system.

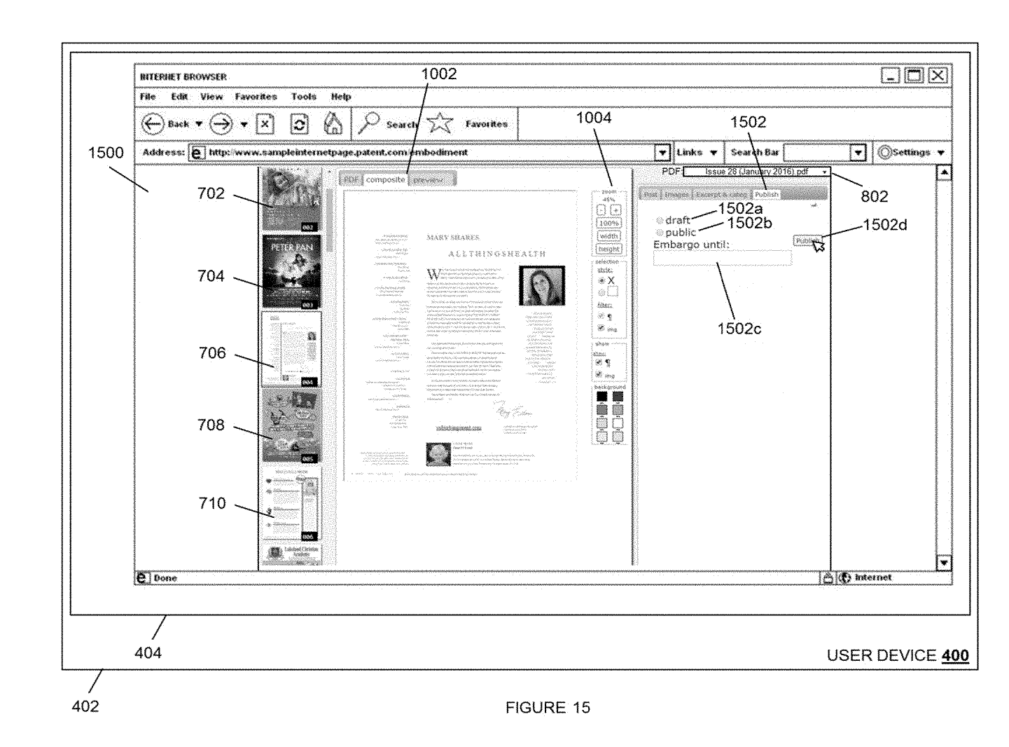

The method 300 then proceeds to block 322 where the user provides a publish command to the digital content conversion system. Referring now to FIG. 15, an embodiment of a publishing portion 1500 of the GUI is illustrated as being displayed on the display device 404 of the user device 400. In an embodiment, the publishing portion 1500 of the GUI may be provided through the network 104 by the web server subsystem 102a in the digital content conversion system 102 and to the user device 400 in response to the selection of the publishing window 1502 on the publishing portion 1500 of the GUI. In the illustrated example, the publishing portion 1500 of the GUI includes each of the page identifiers 702-710 that were provided on the page selection portion 700 of the GUI, as well as a digital document file identifier 802 that identifies the digital content that was provided at block 306, and the publishing window 1502 that includes a draft publishing input 1502a, a public publishing input 1502b, an embargo input 1502c, and a publish element 1502d.

In an embodiment, at block 322, the user may provide details about a publishing command by, for example, selecting the draft publishing input 1502a to provide an instruction to store the selected HTML formatted text data and HTML formatted image data as a draft in the content management system 104, selecting the public publishing input 1502b to provide an instruction to publish to the selected HTML formatted text data and HTML formatted image data as a public post in the content management system 104, optionally providing a date or time in the future on which to publish the selected HTML formatted text data and HTML formatted image data, and selecting the publish element 1502d to send the command to publish the selected HTML formatted text data and HTML formatted image data (including any instructions provided via the draft publishing input 1502a, the public publishing input 1502b, and the embargo input 1502c) to the digital content conversion system 102.

The method 300 then proceeds to block 324 where the digital content conversion system transmits the selected formatted text and image data to a content management system for publishing. In an embodiment, the content conversion engine 204 in the content conversion server subsystem 200 may provide the HTML formatted text data and the HTML formatted image data that was selected at block 318 and, in some embodiments, edited at optional block 320, and provide that HTML formatted text data and the HTML formatted image data to the web server subsystem 102a for transmittal to the content management system 104 associated with the user device (e.g., the content management system connected via the content management system connection portion 500 of the GUI discussed above with reference to FIG. 5.) As discussed above, the digital content conversion subsystem 102 may include information about how content is input to the content management system 104, including title inputs, body inputs, image inputs, and/or other content inputs known in the art. For example, content management system Application Programming Interfaces (APIs) may be utilized by the web server subsystem 102a to transmit the HTML formatted text data and the HTML formatted image data to the content management system 104 (e.g., transmitting a portion of the HTML formatted text data to a title input at the content management system 104, transmitting a portion of the HTML formatted text data to a body input at the content management system 104, etc.) As such, at block 324, the HTML formatted text data and the HTML formatted image data may be provided to the content management system 104 in a content input format so that the content will be displayed in a manner desired by the user (e.g., as display via the preview portions of the GUI discussed above)

Thus, at block 324 the content management system 104 receives the HTML formatted text data and the HTML formatted image data in association with the user, and publishes that HTML formatted text data and the HTML formatted image data. As discussed above, the HTML formatted text data and the HTML formatted image data may be published by the content management system 104 as a “draft” that must be approved for public distribution by the user (e.g., via a “publish” command provided directly to the content management system 104 rather than the digital content conversion system 102), as a public post that is immediately available to the public, and/or as a time-delayed public post that is available to the public at some time designated by the user.

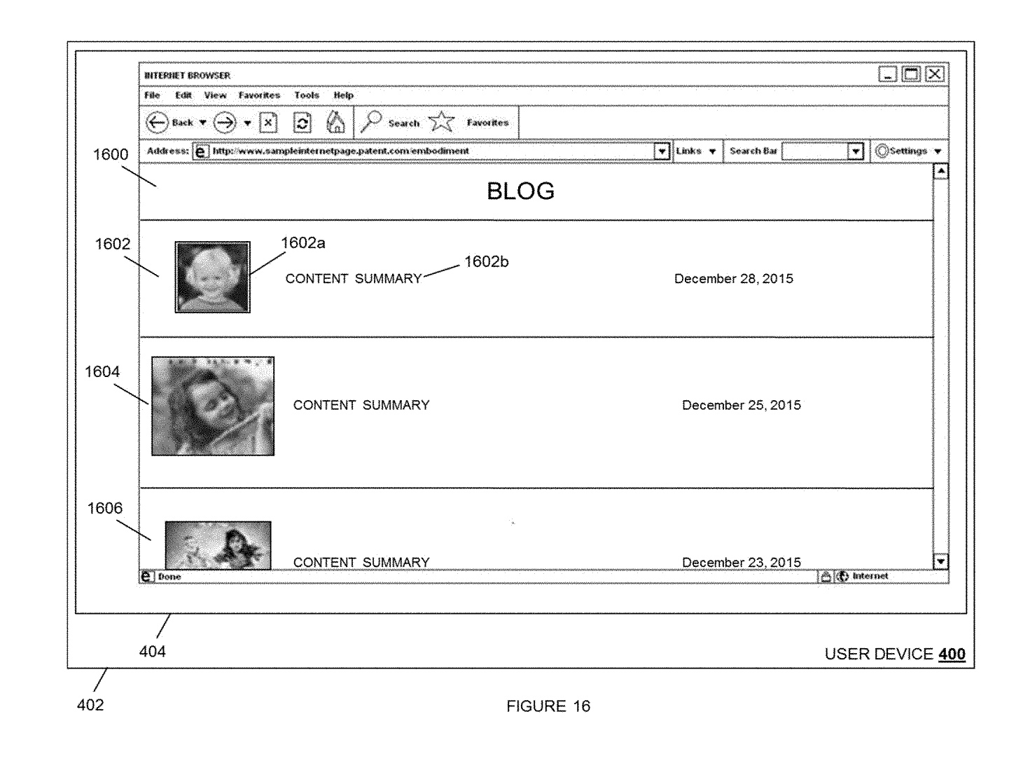

Referring now to FIG. 16, an embodiment of the user device 400 displaying a content management system content summary page 1600 is illustrated. While the user device 400 that interacted with the digital content conversion system 102 during the method 300 is illustrated and described as accessing the content management system content summary page 1600, one of skill in the art in possession of the present disclosure will recognize that any user device (e.g., any user access the content published via the content management system 104) may be utilized to access the content management system content summary page 1600 while remaining within the scope of the present disclosure. Furthermore, while the content management system content summary page 1600 is illustrated and described as a blog content summary page, content management systems other than blogs are envisioned as falling within the scope of the present disclosure as well.

In the illustrated embodiment, the content management system content summary page 1600 include a content summary 1602 that was created during the method 300 discussed above, as well as previously created content summaries 1604 and 1606 (e.g., previously created according to the method 300, or previously created directly using the content management system 104.) As can be seen, the content summary 1602 includes an image 1602a that was provided via the HTML formatted image data (e.g., the “featured image”) selected as discussed above with regard to FIG. 12, and the content summary text provided as discussed above with regard to FIG. 13. As would be understood by one of skill in the art in possession of the present disclosure, users may select the content summary 1602 in order to be provided the content associated with that content summary.

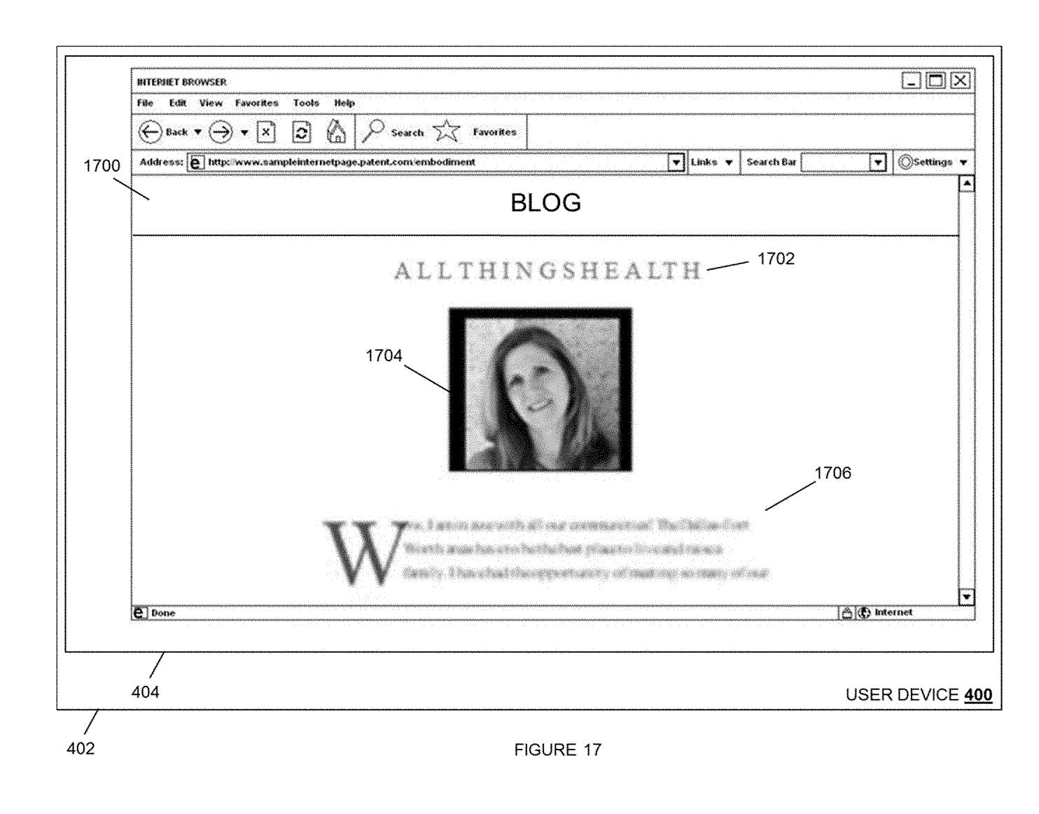

For example, FIG. 17 illustrates an embodiment of the user device 400 displaying a content page 1700 in response to a selection of the content summary 1602. While the user device 400 that interacted with the digital content conversion system 102 during the method 300 is illustrated and described as accessing the content page 1700, one of skill in the art in possession of the present disclosure will recognize that any user device (e.g., any user access the content published via the content management system 104) may be utilized to access the content page 1700 while remaining within the scope of the present disclosure. Furthermore, while the content page 1700 is illustrated and described as a blog page/blog post, content management systems other than blogs are envisioned as falling within the scope of the present disclosure as well. In the illustrated embodiment, the content page 1700 includes text 1702 that was provided via the HTML formatted text data that was selected as discussed above with regard to FIG. 10B, an image 1704 that was provided via the HTML formatted image data selected as discussed above with regard to FIG. 10D, and text 1706 that was provided via the HTML formatted text data that was selected as discussed above with regard to FIG. 10c.

Thus, a system and method for document conversion and publishing has been described that allows users such as, for example, physical and digital publishers, to quickly and easily convert content that has been provided in a static document format such as PDF into content management system compatible formatted data such as HTML formatted text and image data. Furthermore, the systems and methods of the present disclosure allow the user to designate subsets of the content for publishing, which allows the user to designate selected portions of the content that were originally provided in PDF to be published, and also allows the user to edit and/or supplement the content that will be published so that the content may be published in any manner desired by the user. Once the content from the PDF has been converted, selected, and/or edited, that content may be published to the content management system simply by the user providing a publish command that causes the systems and methods to send the converted, selected, and/or edited content directly to the content management system for publishing in a manner that publishes the content for display so that it may be viewed as desired by the user. Embodiments of the systems and methods collect user selections of content converted from the PDF for use with a machine learning system that may then provide suggestions to subsequent users attempting to convert content about which content appears to be high value content, where that content will most likely be positioned, and/or other suggestions that result from recognition of those factors based on a plurality of previous user selections of content. Furthermore, machine learning systems providing according to the teachings of the present disclosure are expected to reach a level of accuracy that will allow physical and digital publishers to provide a variety of content in a first format (e.g., the PDF file discussed above), and have each relevant piece of content recognized, separated, converted, and provided for publishing via a content management system with little to no input required by those physical and digital publishers.

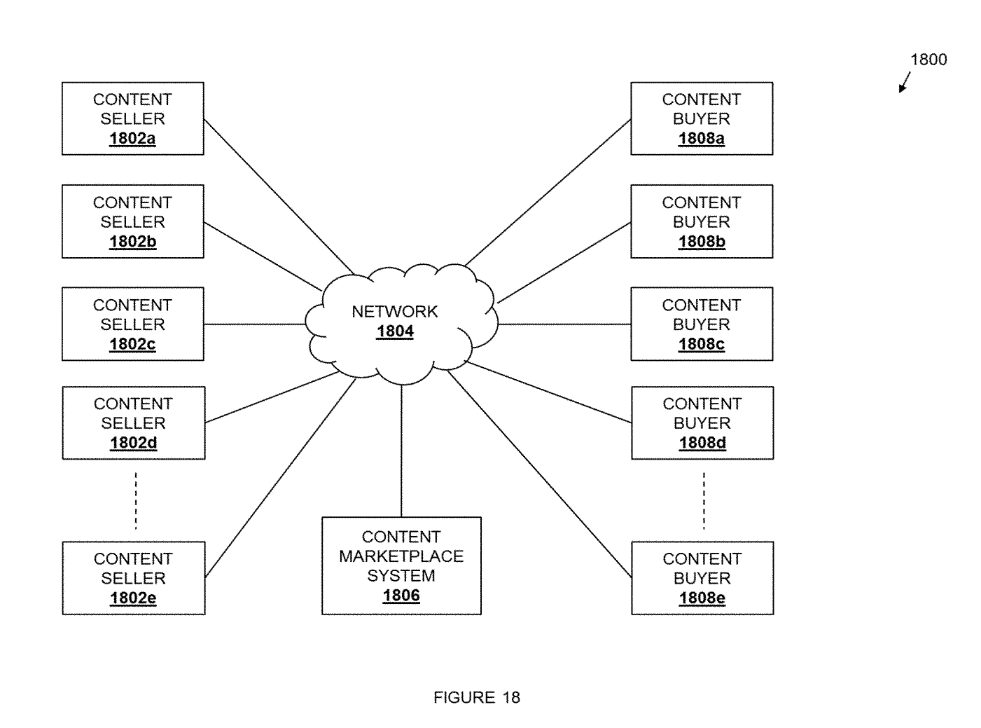

Referring now to FIG. 18, an embodiment of a content marketplace 1800 is illustrated and described below to provide an example of the some of the benefits that may be realized from the operation of the digital content conversion systems and methods discussed above. The content marketplace 1800 includes a plurality of content sellers 1802a, 1802b, 1802c, 1802d, and up to 1802e, that are coupled through a network 1804 to a content marketplace system 1806. In an embodiment, the content sellers 1802a-e may be content creators such as the physical and digital publishers discussed above, content management system users, and/or other content creators known in the art, and may each include a computing device for connecting to the content marketplace system 1806 through the network 104. A plurality of content buyers 1808a, 1808b, 1808c, 1808d, and up to 1808e are also coupled through the network 1804 to the content marketplace system 1806. In an embodiment, the content buyers 1808a-e may be companies and/or other entities running content marketing campaigns that include the sponsoring of content, and may each include a computing device for connecting to the content marketplace system 1806 through the network 104. In some embodiments, the content marketplace system 1806 may include the digital content conversion system 102 discussed above, while in other embodiments, the content marketplace system 1806 may be separate from the digital content conversion system 102 discussed above.

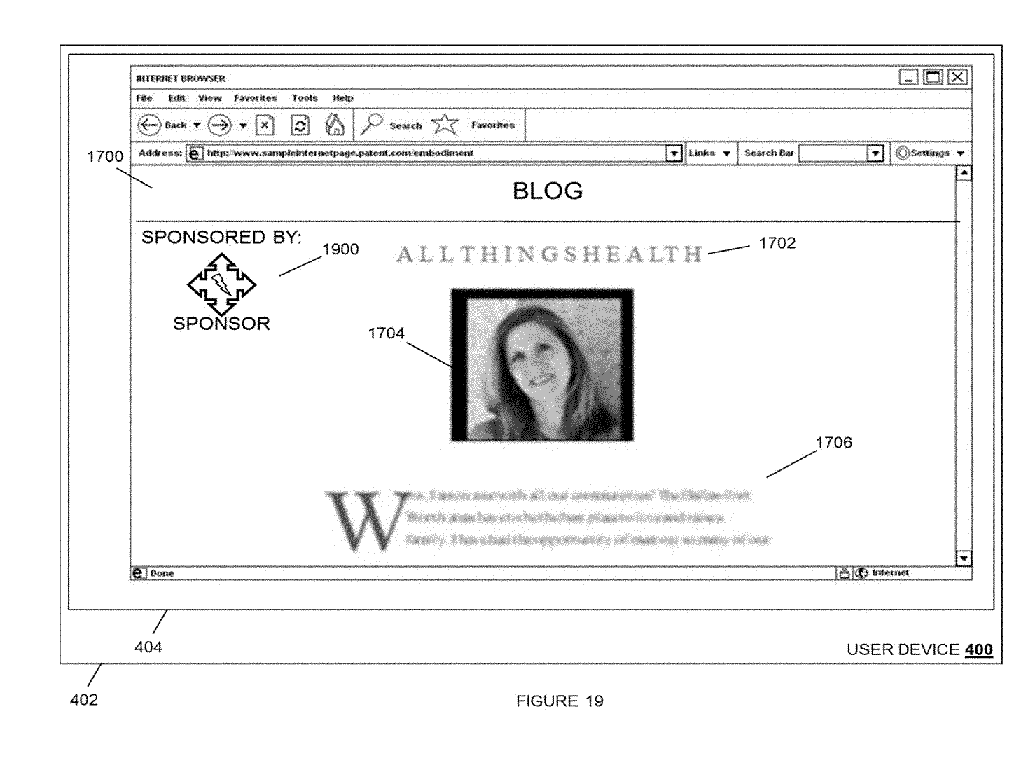

In an embodiment, the GUIs provided by the digital content conversion system 102 discussed above may provide the user the ability to add a sponsor to any digital content that is converted and published. For example, prior or subsequent to publishing the content via the content management system 104 as discussed above, a user may be enabled to add a sponsor to that content by providing sponsor information in a sponsor portion of the GUI (e.g., providing a sponsor name, providing a sponsor logo, and/or providing any other sponsor information known in the art). In response, the digital content conversion system 102 may transmit that sponsor information along with the HTML formatted text data and HTML formatted image data to the content management system for publishing. For example, FIG. 19 illustrates the content page 1700 discussed above with reference to FIG. 17, but with sponsorship information 1900 added to the content page 1700 that identifies a sponsor by their name and logo. As such, a user or content seller may determine and identify their own sponsor or content buyer for their content so that that sponsor/content buyer is identified in their published content.

However, the content marketplace system 1806 may also enable the content marketplace 1800 that provides for the matching of content buyers with content sellers as well, and the utility of content that may be created using the digital content conversion system 102, particularly with regard to the content created and controlled by physical and digital publishers, is envisioned as greatly benefiting from the content marketplace 1800. For example, with the vast amounts of content that may be provided via the digital content conversion system 102, the content buyers 1802a-e may be overwhelmed with the amount of content available, and may be unable to find the content most relevant to their content marketing strategies. To remedy this issue, the content marketplace system 1806 may operate to categorize the content that is created by the content sellers 1802a-e (either directly using the content management systems 104, or via the digital content management system 102) by, for example, analyzing the text in that content to identify key words or phrases that identify the subject matter of that content, analyzing the images in that content to identify images that identify the subject matter of that content, and/or performing other content categorization techniques known in the art. In addition, the content marketplace system 1806 may develop profiles for each of the content sellers 1802a-e, content buyers 1808a-e, and/or content marketing strategies of the content buyers 1808a-e in order to help determine which content is relevant to which content buyer or content marketing strategy.

In some embodiments, profiles of the content sellers may be developed for the content sellers to define content buyers that may sponsor their content. For example, a content seller may authorize particular content buyers to sponsor their content, particular categories of content buyers to sponsor their content, and/or may provide for the filtering of content buyers in any other manner to define the content buyers that may or may not sponsor their content. As such, content creators/sellers may have varying degrees of control over how and by whom their content may be sponsored.

The profiles discussed above allow the content marketplace system 1806 to match content from any of the content buyers 1802a-e with any of the content sellers 1808a-e in order to facilitate the purchasing of the content from the content sellers 1802a-e by the content buyers 1808a-e. Such facilitation may involve the content marketplace providing GUIs, emails, or other communications that present the most relevant content to a content buyer based on their content buyer profile or content marketing strategy profile(s), in some cases subsequent to filtering that content using the content seller profiles. As such, content sellers may provide content (e.g., via the digital content conversion systems and methods discussed above) to the content marketplace system 1806, and then have that content matched to prospective content buyers. However, while a specific embodiment of the use of the digital content conversion system of the present disclosure is described herein, one of skill in the art in possession of the present disclosure will recognize that a variety of other uses of the digital content conversion system will fall within the scope of the present disclosure as well.

Furthermore, other modifications to the content marketplace 1800 may include the auction of content from the content sellers 1802a-e to the content buyers 1808a-e, which allows, for example, content buyers to obtain exclusive access to highly valued content in a manner that may be most beneficial to the content sellers. Further still, the content marketplace system 1806 may provide the ability to “amplify” content that is sponsored. For example, GUIs similar to those discussed above may provide content buyers the ability to buy content advertisements (e.g., on social media websites, application, etc.) that direct possible customers to the content published by the content management system 104, thus “amplifying” the number of users that may view the content. Further still, the content management system 1806 may monitor (e.g., in conjunction with the content management system 104) the views and other user interactions with published and/or sponsored content, which may enable the ability to combine separately provided content (e.g., from different content sellers and/or buyers) into a physical or digital publication (i.e., the most popular content in a particular category over a particular time period could be published as an issue of a physical magazine.) Thus, a wide variety of modifications to (and benefits from) the content marketplace are envisioned as falling within the scope of the present disclosure.

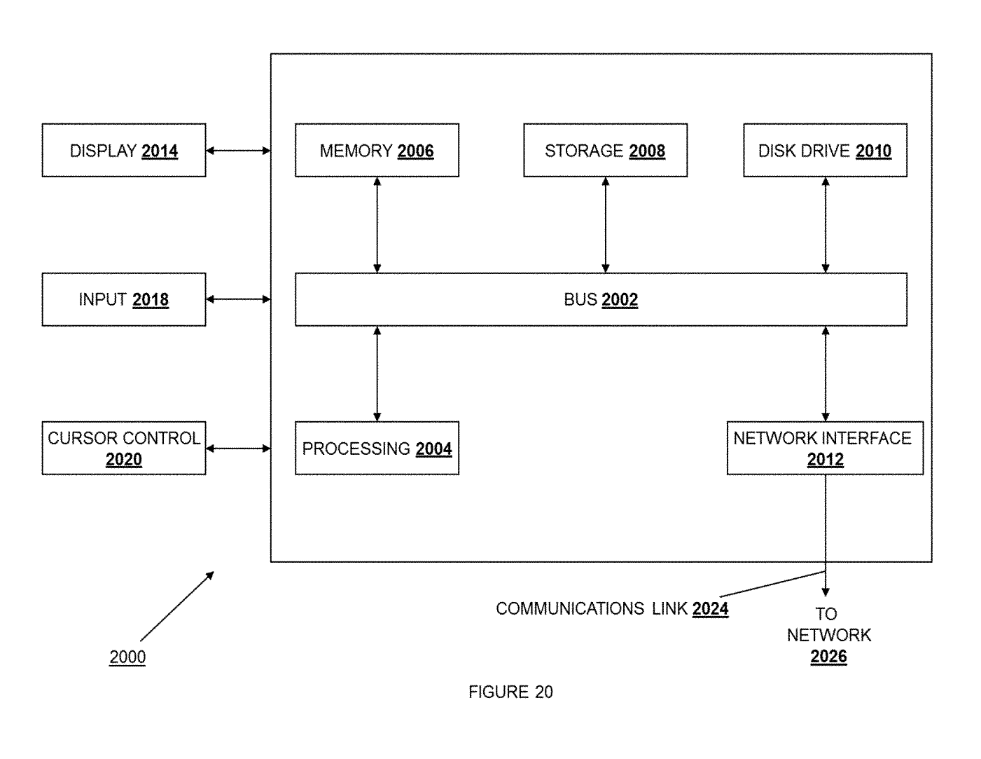

Referring now to FIG. 20, an embodiment of a computer system 2000 suitable for implementing, for example, the digital content conversion system 102, the web server subsystem 102a, the content conversion server subsystem 102b, the content management systems 104 and 200, and/or the user devices 108a-e, is illustrated. It should be appreciated that other devices in the system discussed above may be implemented as the computer system 2000 in a manner as follows.

In accordance with various embodiments of the present disclosure, computer system 2000, such as a computer and/or a network server, includes a bus 2002 or other communication mechanism for communicating information, which interconnects subsystems and components, such as a processing component 2004 (e.g., processor, micro-controller, digital signal processor (DSP), etc.), a system memory component 2006 (e.g., RAM), a static storage component 2008 (e.g., ROM), a disk drive component 2010 (e.g., magnetic, optical, solid state), a network interface component 2012 (e.g., modem or Ethernet card), a display component 2014 (e.g., CRT, LCD, LED), an input component 2018 (e.g., keyboard, keypad, or virtual keyboard), a cursor control component 2020 (e.g., mouse, pointer, trackball, touchscreen), and/or other computer system components known in the art. In one implementation, the disk drive component 2010 may comprise a database having one or more disk drive components.

In accordance with embodiments of the present disclosure, the computer system 2000 performs specific operations by the processor 2004 executing one or more sequences of instructions contained in the memory component 2006. Such instructions may be read into the system memory component 2006 from another computer readable medium, such as the static storage component 2008 or the disk drive component 2010. In other embodiments, hard-wired circuitry may be used in place of or in combination with software instructions to implement the present disclosure.

Logic may be encoded in a computer readable medium, which may refer to any medium that participates in providing instructions to the processor 2004 for execution. Such a medium may take many forms, including but not limited to, non-volatile media, volatile media, and transmission media. In several embodiments, the computer readable medium is non-transitory. In various implementations, non-volatile media includes optical or magnetic disks, such as the disk drive component 2010, volatile media includes dynamic memory, such as the system memory component 2006, and transmission media includes coaxial cables, copper wire, and fiber optics, including wires that comprise the bus 2002. In one example, transmission media may take the form of acoustic waves, light waves, or electromagnetic signals such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read. In one embodiment, the computer readable media is non-transitory.

In various embodiments of the present disclosure, execution of instruction sequences to practice the present disclosure may be performed by the computer system 2000. In various other embodiments of the present disclosure, a plurality of the computer systems 2000 coupled by a communication link 2024 to a network 2026 (e.g., such as a LAN, WLAN, PTSN, and/or various other wired or wireless networks, including telecommunications, mobile, and cellular phone networks) may perform instruction sequences to practice the present disclosure in coordination with one another.

The computer system 2000 may transmit and receive messages, data, information and instructions, including one or more programs (i.e., application code) through the communication link 2024 and the network interface component 2012. The network interface component 2012 may include an antenna, either separate or integrated, to enable transmission and reception via the communication link 2024. Received program code may be executed by processor 2004 as received and/or stored in disk drive component 2010 or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the scope of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A digital content conversion system, comprising:
a non-transitory memory system;
a processing system that is coupled to the non-transitory memory system and configured to read instructions from the non-transitory memory system to cause the digital content conversion system to perform operations comprising:
providing, through a network for display on a user device, a graphical user interface;
receiving, through the network via the graphical user interface provided on the user device, a Portable Document Format (PDF) file;
analyzing the PDF file to identify each page included in the PDF file;
providing, through the network for display on the user device via the graphical user interface, an identification of at least one page included in the PDF file;
receiving, through the network via the graphical user interface provided on the user device, a selection of a first page in the PDF file that was identified through the graphical user interface;
processing the first page in the PDF file to extract a plurality of text elements, text element location information, an image element, and image element location information from the PDF file;
formatting the plurality of text elements using the text element location information to provide Hypertext Markup Language (HTML) formatted text data;
formatting the image element using the image element location information to provide HTML formatted image data;
providing, through the network for display on the user device via the graphical user interface, a composite content element layout that includes the HTML formatted text data and the HTML formatted image data;
receiving a selection of a subset of the HTML formatted text data in the composite content element layout;
receiving, through the network via the graphical user interface provided on the user device, a selection of the HTML formatted image data in the composite content element layout; and
receiving, through the network via the graphical user interface provided on the user device, a command to publish the subset of HTML formatted text data and the HTML formatted image data and, in response, transmitting the subset of HTML formatted text data and the HTML formatted image data through the network to a content management system for publishing.

2. The system of claim 1, wherein the operations further comprise:
extracting, in response to receiving the selection of the first page in the PDF file that was identified through the graphical user interface, the first page of the PDF file; and
providing, through the network for display on the user device via the graphical user interface, the first page of the PDF file.

3. The system of claim 1, wherein the operations further comprise:
transmitting, through the network to the content management system prior to receiving the command to publish the subset of HTML formatted text data and the HTML formatted image data, at least some of the subset of HTML formatted text data and the HTML formatted image data for previewing;
receiving, through the network from the content management system, a content preview of the at least some of the subset of the HTML formatted text data and the HTML formatted image data; and
providing, through the network for display on the user device via the graphical user interface, the content preview.

4. The system of claim 1, wherein the operations further comprise:
providing, through the network for display on the user device via the graphical user interface, the subset of HTML formatted text data and the HTML formatted image data; and
receiving, through the network via the graphical user interface provided on the user device, at least one edit to at least one of the subset of HTML formatted text data and the HTML formatted image data and, in response, modifying the at least one of the subset HTML formatted text data and the HTML formatted image data prior to transmitting the subset of HTML formatted text data and the HTML formatted image data through the network to the content management system for publishing.

5. The system of claim 1, wherein the processing the first page in the PDF file to extract the plurality of text elements, text element location information, the image element, and image element location information from the PDF file includes:
converting data in the PDF file to an Extensible Markup Language (XML) format in an XML file that identifies each of the plurality of text elements and their associated text element location information, and the image element and its associated image location information, and wherein the formatting the plurality of text elements using the text element location information to provide HTML formatted text data, and the formatting the image element using the image element location information to provide HTML formatted image data includes:
processing the XML file to convert the identification of each of the plurality of text elements and their associated text element location information to HTML formatted text data; and
processing the XML file to convert the identification of the image element and its associated image element location information to HTML formatted image data.

6. The system of claim 1, wherein the providing the identification of at least one page included in the PDF file includes:
capturing an image of the at least one page included in the PDF file; and
providing, through the network for display on the user device via the graphical user interface, each image of the at least one page included in the PDF file, and wherein the receiving the selection of a first page in the PDF file includes receiving the selection of image of the first page in the PDF file.

7. A method for converting digital content for publishing, comprising:
providing, by a digital content conversion system through a network for display on a user device, a graphical user interface;
receiving, by the digital content conversion system through the network via the graphical user interface provided on the user device, a Portable Document Format (PDF) file;
analyzing, by the digital content conversion system, the PDF file to identify each page included in the PDF file;
providing, by the digital content conversion system through the network for display on the user device via the graphical user interface, the identification of the at least one page included in the PDF file;
receiving, by the digital content conversion system through the network via the graphical user interface provided on the user device, a selection of a first page in the PDF file that was identified through the graphical user interface;
processing, by the digital content conversion system, the first page in the PDF file to extract a plurality of text elements, text element location information, an image element, and image element location information from the PDF file;
formatting, by the digital content conversion system, the plurality of text elements using the text element location information to provide HTML formatted text data;
formatting, by the digital content conversion system, the image element using the image element location information to provide HTML formatted image data;
providing, by the digital content conversion system through the network for display on the user device via the graphical user interface, a composite Hypertext Transfer Protocol (HTML) layout that includes the HTML formatted text data and the HTML formatted image data;
receiving, by the digital content conversion system through the network via the graphical user interface provided on the user device, a selection of a subset of the HTML formatted text data in the composite content element layout;
receiving, by the digital content conversion system through the network via the graphical user interface provided on the user device, a selection of the HTML formatted image data in the composite content element layout; and
receiving, by the digital content conversion system through the network via the graphical user interface provided on the user device, a command to publish the subset of HTML formatted text data and the HTML formatted image data and, in response, transmitting the subset of HTML formatted text data and the HTML formatted image data through the network to a content management system for publishing.

8. The method of claim 7, further comprising:
extracting, by the digital content conversion system in response to receiving the selection of the first page in the PDF file that was identified through the graphical user interface, the first page of the PDF file; and
providing, by the digital content conversion system through the network for display on the user device via the graphical user interface, the first page of the PDF file.

9. The method of claim 7, further comprising:
transmitting, by the digital content conversion system through the network to the content management system prior to receiving the command to publish the subset of HTML formatted text data and the HTML formatted image data, at least some of the subset of HTML formatted text data and the HTML formatted image data for previewing;
receiving, by the digital content conversion system through the network from the content management system, a content preview of the at least some of the subset of the HTML formatted text data and the HTML formatted image data; and
providing, by the digital content conversion system through the network for display on the user device via the graphical user interface, the content preview.

10. The method of claim 7, further comprising:
providing, by the digital content conversion system through the network for display on the user device via the graphical user interface, the subset of HTML formatted text data and the HTML formatted image data; and
receiving, by the digital content conversion system, at least one edit to at least one of the subset of HTML formatted text data and the HTML formatted image data and, in response, modifying the at least one of the subset HTML formatted text data and the HTML formatted image data prior to transmitting the subset of HTML formatted text data and the HTML formatted image data through the network to the content management system for publishing.

11. The method of claim 7, wherein the processing the first page in the PDF file to extract the plurality of text elements, text element location information, the image element, and image element location information from the PDF file includes:
converting, by the digital content conversion system, data in the PDF file to an Extensible Markup Language (XML) format in an XML file that identifies each of the plurality of text elements and their associated text element location information, and the image element and its associated image location information, and wherein the formatting the plurality of text elements using the text element location information to provide HTML formatted text data, and the formatting the image element using the image element location information to provide HTML formatted image data includes:
processing, by the digital content conversion system, the XML file to convert the identification of each of the plurality of text elements and their associated text element location information to HTML formatted text data; and
processing, by the digital content conversion system, the XML file to convert the identification of the image element and its associated image element location information to HTML formatted image data.

12. The method of claim 7, wherein the providing the identification of at least one page included in the PDF file includes:
capturing, by the digital content conversion system, an image of the at least one page included in the PDF file; and
providing, by the digital content conversion system through the network for display on the user device via the graphical user interface, each image of the at least one page included in the PDF file, and wherein the receiving the selection of a first page in the PDF file includes receiving the selection of image of the first page in the PDF file.

13. The method of claim 7, further comprising:
storing, by the digital content conversion system, the selection of the subset of the HTML formatted text data and the selection of the HTML formatted image data in association with the PDF file in a machine learning database, wherein the machine learning database includes a plurality of previous selections of HTML formatted text data and HTML formatted image data in association with previously received PDF files; and
determining, by the digital content conversion system using the machine learning database, a likelihood of a selection of at least one of HTML formatted text data and HTML formatted image data in a subsequently received PDF file.

14. A non-transitory machine-readable medium having stored thereon machine-readable instructions executable to cause a machine to perform operations comprising:
providing, for display on a user device, a graphical user interface;
receiving, via the graphical user interface provided on the user device, a Portable Document Format (PDF) file;
analyzing the PDF file to identify each page included in the PDF file;
providing, for display on the user device via the graphical user interface, an identification of at least one page included in the PDF file;
receiving, via the graphical user interface provided on the user device, a selection of a first page in the PDF file that was identified through the graphical user interface;
processing the first page in the PDF file to extract a plurality of text elements, text element location information, an image element, and image element location information from the PDF file;
formatting the plurality of text elements using the text element location information to provide HTML formatted text data;
formatting the image element using the image element location information to provide HTML formatted image data;
providing, for display on the user device via the graphical user interface, a composite Hypertext Transfer Protocol (HTML) layout that includes the HTML formatted text data and the HTML formatted image data;
receiving a selection of a subset of the HTML formatted text data in the composite content element layout;
receiving, via the graphical user interface provided on the user device, a selection of the HTML formatted image data in the composite content element layout; and
receiving, via the graphical user interface provided on the user device, a command to publish the subset of HTML formatted text data and the HTML formatted image data and, in response, transmitting the subset of HTML formatted text data and the HTML formatted image data through a network to a content management system for publishing.

15. The non-transitory machine-readable medium of claim 14, wherein the operations further comprise:
extracting, in response to receiving the selection of the first page in the PDF file that was identified through the graphical user interface, the first page of the PDF file; and
providing, for display on the user device via the graphical user interface, the first page of the PDF file.

16. The non-transitory machine-readable medium of claim 14, wherein the operations further comprise:
transmitting, through the network to the content management system prior to receiving the command to publish the subset of HTML formatted text data and the HTML formatted image data, at least some of the subset of HTML formatted text data and the HTML formatted image data for previewing;
receiving, through the network from the content management system, a content preview of the at least some of the subset of the HTML formatted text data and the HTML formatted image data; and
providing, for display on the user device via the graphical user interface, the content preview.

17. The non-transitory machine-readable medium of claim 14, wherein the operations further comprise:
providing, for display on the user device via the graphical user interface, the subset of HTML formatted text data and the HTML formatted image data; and
receiving, via the graphical user interface provided on the user device, at least one edit to at least one of the subset of HTML formatted text data and the HTML formatted image data and, in response, modifying the at least one of the subset HTML formatted text data and the HTML formatted image data prior to transmitting the subset of HTML formatted text data and the HTML formatted image data through the network to the content management system for publishing.

18. The non-transitory machine-readable medium of claim 14, wherein the processing the first page in the PDF file to extract the plurality of text elements, text element location information, the image element, and image element location information from the PDF file includes:
converting data in the PDF file to an Extensible Markup Language (XML) format in an XML file that identifies each of the plurality of text elements and their associated text element location information, and the image element and its associated image location information, and wherein the formatting the plurality of text elements using the text element location information to provide HTML formatted text data, and the formatting the image element using the image element location information to provide HTML formatted image data includes:
processing the XML file to convert the identification of each of the plurality of text elements their associated text element location information to HTML formatted text data; and
processing the XML file to convert the identification of the image element and its associated image element location information to HTML formatted image data.

19. The non-transitory machine-readable medium of claim 14, wherein the providing the identification of at least one page included in the PDF file includes:
capturing an image of the at least one page included in the PDF file; and
providing, for display on the user device via the graphical user interface, each image of the at least one page included in the PDF file, and wherein the receiving the selection of a first page in the PDF file includes receiving the selection of image of the first page in the PDF file.

20. The non-transitory machine-readable medium of claim 14, wherein the operations further comprise:
providing the selection of the subset of the HTML formatted text data and the selection of the HTML formatted image data in association with the PDF file in a machine learning database, wherein the machine learning database includes a plurality of previous selections of HTML formatted text data and HTML formatted image data in association with previously received PDF files; and
determining, using the machine learning database, a likelihood of a selection of at least one of HTML formatted text data and HTML formatted image data in a subsequently received PDF file.
